(19) United States
(12) Patent Application Publication
(10) Pub. No.: US 2026/0207418 A1
(43) Pub. Date: Jul. 23, 2026

(54) EXERCISE AND THERAPY DEVICE

(71) Applicant: Jean-Patrick Netter, Encinitas, CA (US)

(72) Inventors: Jean-Patrick Netter, Encinitas, CA (US); Dorian Alberti, Madison, FL (US); John Michael Davis, Las Vegas, NV (US); Mallory E. Warren, La Mesa, CA (US); James Siedenburg, Hampton, NH (US)

(21) Appl. No.: 19/566,446

(22) Filed: Mar. 13, 2026

Related U.S. Application Data
(63) Continuation-in-part of application No. 19/094,110, filed on Mar. 28, 2025, now Pat. No. 12,576,299.
(60) Provisional application No. 63/571,915, filed on Mar. 29, 2024.

(51) Int. Cl. A61H 15/00

(52) U.S. Cl. CPC A61H 15/0078; A61H 2015/0021; A61H 2201/1692; A61H 2201/5048; A61H 2201/5058; A61H 2205/12

(57) ABSTRACT

A device may include a base, a housing, a first shaft, and a second shaft, a first roller coupled to the first shaft, a second roller coupled to the second shaft, a first resistance that selectively impedes the rotation of the first roller and a second resistance that selectively impedes the rotation of the second roller, wherein the first shaft and second shaft are rotatable independently of each other, the first resistance is adjustable such that increasing the first resistance increases a force required to rotate the first roller and decreasing the first resistance decreases the force required to rotate the first roller, the second resistance is adjustable such that increasing the second resistance increases a force required to rotate the second roller and decreasing the second resistance decreases the force required to rotate the second roller, and the first resistance and the second resistance are independently adjustable.

### PRIORITY CLAIM AND INCORPORATION BY REFERENCE

Any and all applications for which a foreign or domestic priority claim is identified in the Application Data Sheet as filed with the present application are hereby incorporated by reference under 37 CFR 1.57.

### FIELD

The present disclosure generally relates to exercise and therapy devices and methods of using the same.

### BACKGROUND

Many individuals spend much of their time sitting, living primarily sedentary lives with minimal exercise. This can lead to various health issues such as poor circulation, weight gain, and/or chronic pain, especially in the feet and legs. Many conventional exercise techniques and devices that target the feet and legs are often inconvenient or uncomfortable to utilize while sitting. Traditional sitting exercise devices that target the feet and/or legs can be expensive, heavy, and/or cumbersome to deploy. For example, sitting treadmills are expensive to manufacture, heavy, and cumbersome to move and deploy, especially for the elderly or infirm. Furthermore, sitting treadmills can prove uncomfortable to use due to the unnatural angle between a sitting user's feet/legs and the relatively flat treadmill surface. Additionally, traditional sitting exercise devices for the feet and/or legs can fail to provide independent exercise regimen for each foot and/or leg that can be tailored to the needs of each foot and/or leg individually. For example, sitting treadmills can require a user to move both feet and/or legs at the same pace. Thus, there exists a need for an affordable, easily portable device that permits sitting exercise while maintaining the comfort of the user and providing independent exercise options for each foot and/or leg. Disclosed herein are exercise and therapy devices and methods of using the same that address at least the foregoing issues.

### SUMMARY OF SOME EXAMPLE EMBODIMENTS

Disclosed herein are embodiments of an exercise device. In any embodiments disclosed herein, the exercise device can be used for therapy and can, therefore, also be referred to herein as a therapy device. In some embodiments, the exercise and therapy device can include a pair of rollers that can be rotated by a user's feet and/or legs to exercise and massage a user's feet and/or legs. The rollers can be operated and/or controlled independently from each other such that the rollers can be rotated at different speeds and/or in different directions simultaneously. The rotation of the rollers can be impeded by a resistance that affects the amount of force required to rotate the rollers. The resistance impeding rotation of the rollers can be adjusted to change the amount of force required to rotate the rollers, increasing or decreasing the difficulty of the exercise. In some embodiments, the resistance that impedes the rotation of each roller can be independently adjusted, such that the force required to rotate one roller can be adjusted without changing the force required to rotate another roller. This can permit a user to tailor the difficulty of the exercise to the needs of each foot and/or leg. In other embodiments, the exercise device can be configured such the resistance that impedes the rotation of each roller can be simultaneously adjusted. The rollers can include surface features such as a plurality of projections to massage a user's feet and/or legs when they are in contact with the rollers.

In some embodiments, the exercise and therapy device can include a base, a housing coupled to the base, a first shaft extending from a first side of the housing, a second shaft extending from a second side of the housing opposite the first side of the housing, the second shaft being coaxial with the first shaft, a first roller coupled to the first shaft such that a rotation of the first roller causes an equal and simultaneous rotation of the first shaft, a second roller coupled to the second shaft such that a rotation of the second roller causes an equal and simultaneous rotation of the second shaft, a first resistance that selectively impedes the rotation of the first roller, and a second resistance that selectively impedes the rotation of the second roller, wherein the first and second shafts can be rotated in either a clockwise or a counter-clockwise direction, the first shaft is rotatable independently of the second shaft and the second shaft is rotatable independently of the first shaft, the first resistance is adjustable such that increasing the first resistance increases a force required to rotate the first roller and decreasing the first resistance decreases the force required to rotate the first roller, the second resistance is adjustable such that increasing the second resistance increases a force required to rotate the second roller and decreasing the second resistance decreases the force required to rotate the second roller, and the first resistance and the second resistance are independently adjustable.

In some embodiments of the exercise and therapy device disclosed herein, the first roller can include an outer surface and a plurality of projections extending outwardly away from the outer surface of the first roller, and the second roller can include an outer surface and a plurality of projections extending outwardly away from the outer surface of the second roller.

In some embodiments, the exercise and therapy device can further include a first friction member configured to exert a first frictional force on the first shaft, a second friction member configured to exert a second frictional force on the second shaft, wherein the first frictional force is adjustable such that increasing the first frictional force increases the first resistance and decreasing the first frictional force decreases the first resistance, the second frictional force is adjustable such that increasing the second frictional force increases the second resistance and decreasing the second frictional force decreases the second resistance, and the first frictional force and the second frictional force are independently adjustable.

In some embodiments of the exercise and therapy device disclosed herein, the first friction member can include a first belt, and the second friction member can include a second belt.

In some embodiments, the exercise and therapy device can further include a first actuator configured to adjust the tension of the first belt, a second actuator configured to adjust the tension of the second belt, wherein increasing the tension of the first belt increases the first frictional force and decreasing the tension of the first belt decreases the first frictional force, and increasing the tension in the second belt increases the second frictional force and decreasing the tension in the second belt decreases the second frictional force.

In some embodiments of the exercise and therapy device disclosed herein, the first actuator can include a first arm, the first arm being configured to extend and retract, the second actuator can include a second arm, the second arm configured to extend and retract, the first belt is coupled to the first arm, the second belt is coupled to the second arm, extending the first arm increases the tension in the first belt and retracting the first arm decreases the tension in the first belt, and extending the second arm increases the tension in the second belt and retracting the second arm decreases the tension in the second belt.

In some embodiments, the exercise and therapy device can further include a plurality of light emitters configured to emit light with a wavelength between 600 nm and 850 nm, the plurality of light emitters being positioned beneath a transparent or semi-transparent top surface of the base.

In some embodiments of the exercise and therapy device disclosed herein, the first roller further can include a first plurality of light emitters configured to emit light with a wavelength between 600 nm and 850 nm, and the second roller can further include a second plurality of light emitters configured to emit light with a wavelength between 600 nm and 850 nm.

In some embodiments of the exercise and therapy device disclosed herein, the first roller is approximately cylindrical in shape, the first roller including a variable diameter, a first and second end of the first roller have a first, maximum diameter, portions of the first roller between the first and second ends have diameters that are less than the first, maximum diameter, and a center portion of the first roller is located approximately halfway between the first and second end of the first roller and has a diameter that is greater than the diameter of portions of the first roller adjacent to the center portion.

In some embodiments, the exercise and therapy device can further include a first base portion including a first end and a second end, and a second base portion including a first end and a second end, wherein the first base portion and the second base portion are positioned on opposite, lateral sides of the housing, the first base portion is tapered such that the first end of the first base portion is narrower than the second end of the first base portion, the second base portion is tapered such that the first end of the second base portion is narrower than the second end of the second base portion,

In some embodiments, the exercise and therapy device can further include a first base portion including a first plurality of light emitters, and a transparent or semi-transparent top surface, and a second base portion including a second plurality of light emitters, and a transparent of semi-transparent top surface, wherein the first base portion and the second base portion are positioned on opposite, lateral sides of the housing, and the first plurality of light emitters and the second plurality of light emitters are configured to emit light with a wavelength between 600 nm and 850 nm.

In some embodiments, the exercise and therapy device can further include one or more displays configured to display a first numerical value representing the first resistance and a second numerical value representing the second resistance.

In some embodiments, the exercise and therapy device can further include a first sensor configured to emit a signal when the first shaft completes a rotation, and a second sensor configured to emit a signal when the second shaft completes a rotation.

In some embodiments, the techniques described herein relate to a method for exercising at least a user's lower legs, including applying a first force to a first roller to rotate the first roller, wherein a rotation of the first roller is resisted by a first resistance force, applying a second force to rotate a second roller, wherein a rotation of the second roller is resisted by a second resistance force, increasing the first resistance force independently of the second resistance force to increase a force required to rotate the first roller without changing the second resistance force.

In some embodiments, the techniques described herein relate to a method, wherein applying the first force to the first roller rotates a first shaft, wherein a rotation of the first shaft is resisted by a first frictional force, and applying the second force to the second roller rotates a second shaft, wherein a rotation of the second shaft is resisted by a second frictional force.

In some embodiments, the techniques described herein relate to a method, which can further include increasing the first frictional force independently of the second frictional force to increase a force required to rotate the first shaft without changing the second frictional force, wherein increasing the first frictional force increases the first resistance force.

In some embodiments, the techniques described herein relate to a method, which can further include increasing a tension of a first friction member to increase the first frictional force independently of the second frictional force.

In some embodiments, the techniques described herein relate to a method, wherein the first friction member includes a belt.

In some embodiments, the techniques described herein relate to a method, wherein increasing the tension of the first friction member includes extending a first actuator coupled to the first friction member.

In some embodiments, the techniques described herein relate to a method, further including emitting light between 600 nm and 850 nm, wherein the light is emitted by a plurality of light emitters.

### BRIEF DESCRIPTION OF THE DRAWINGS

Various embodiments are depicted in the accompanying drawings for illustrative purposes, and should in no way be interpreted as limiting the scope of the embodiments. Various features of different disclosed embodiments can be combined to form additional embodiments, which are part of this disclosure.

FIG. 1 illustrates a front, top perspective view of an embodiment of an exercise and therapy device.

FIG. 2 illustrates a front view of the exercise and therapy device of FIG. 1.

FIG. 3 illustrates a rear view of the exercise and therapy device of FIG. 1.

FIG. 4 illustrates a top view of the exercise and therapy device of FIG. 1.

FIG. 5 illustrates a bottom view of the exercise and therapy device of FIG. 1.

FIG. 6 illustrates a side view of the exercise and therapy device of FIG. 1.

FIG. 7 illustrates a front, top perspective view of the exercise and therapy device of FIG. 1 with a portion of the housing removed.

FIG. 8 illustrates a rear view of the exercise and therapy device of FIG. 1 with a portion of the housing removed.

FIG. 9 illustrates a top view of an embodiment of a remote.

FIG. 10 illustrates a front, top perspective view of another embodiment of an exercise and therapy device.

FIGS. 11A-11C illustrate side, top perspective views of the exercise and therapy device of FIG. 10 in use by a user.

FIG. 12 illustrates a front, top perspective view of another embodiment of an exercise and therapy device.

FIG. 13 illustrates a front, top perspective view of another embodiment of an exercise and therapy device.

FIG. 14 illustrates a front, top perspective view of another embodiment of an exercise and therapy device.

FIG. 15A illustrates a front, top perspective view of another embodiment of an exercise and therapy device.

FIG. 15B illustrates a front view of the exercise and therapy device of FIG. 15A.

FIG. 15C illustrates a side view of the exercise and therapy device of FIG. 15A.

FIG. 15D illustrates a top view of the exercise and therapy device of FIG. 15A.

FIG. 15E illustrates a front, top perspective view of the exercise and therapy device of FIG. 15A with a housing of the exercise and therapy device shown as transparent and certain components of the exercise and therapy device removed.

FIG. 15F illustrates a front, top perspective view of the exercise and therapy device of FIG. 15A with certain components of the exercise and therapy device removed.

FIG. 16A illustrates a front, top perspective view of another embodiment of an exercise and therapy device.

FIG. 16B illustrates a front view of the exercise and therapy device of FIG. 16A.

FIG. 16C illustrates a side, cross-sectional view of the exercise and therapy device of FIG. 16A.

FIG. 16D illustrates a top view of the exercise and therapy device of FIG. 16A.

FIG. 16E illustrates a side view of the exercise and therapy device of FIG. 16A.

FIG. 16F illustrates a front, cross-sectional view of the exercise and therapy device of FIG. 16A.

FIG. 16G illustrates a front, cross-sectional view of a first portion of the exercise and therapy device of FIG. 16A.

### DETAILED DESCRIPTION OF SOME EXAMPLE EMBODIMENTS

Disclosed herein are various embodiments of an exercise and therapy device and methods of using the same. Any of the embodiments of the exercise and therapy device can provide exercise, physical therapy, and massage to portions of the user's body, for example, the user's feet and/or legs. In some embodiments of the exercise and therapy device disclosed herein, the device is configured to be used while a user is seated. The disclosed exercise and therapy devices can be transported easily due to their light weight and compact size. Some embodiments of the disclosed exercise and therapy device disclosed herein can include a pair of rollers that can be rotated independently of each other such that each roller can be rotated at different speeds and/or in different directions. A user can rotate one or more roller(s) by contacting the roller(s) with his or her feet and/or legs and using his or her feet and/or legs to exert a force on the roller(s). Rotating the rollers can exercise and/or massage a user's feet and/or legs. The rollers can be rotated in the same direction or in opposite directions simultaneously. The rollers can be rotated at the same speed or at different speeds.

The rotation of the rollers can be impeded by an adjustable resistance such that the force required to rotate each roller can be adjusted—e.g., without limitation, increased or decreased. In some embodiments, the resistance acting against the rotation of each roller can be independently adjusted such that the force required to rotate each roller can be independently changed without changing the amount of force required to rotate the other roller. The rollers can include textured surfaces with a plurality of projections (also referred to herein as protrusions) and/or recesses to massage a user's feet and/or legs when a user's feet and/or legs are in contact with the rollers. Some embodiments of the exercise and therapy devices can include a plurality of light emitters that can emit red light to provide red light therapy. A user can position his or her feet proximate the light emitters such that the red light is at least partially received by a user's feet. Additionally, in some embodiments, the exercise and therapy devices can include gamified engagement including progress tracking and real-time feedback to increase user engagement.

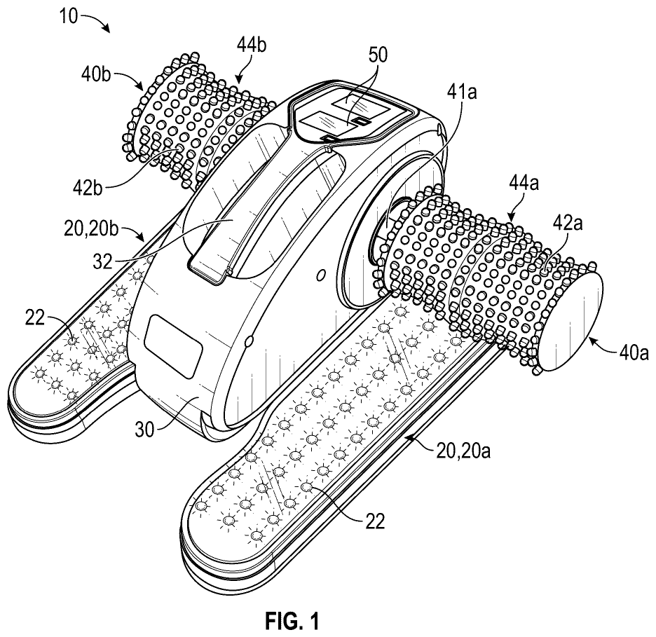

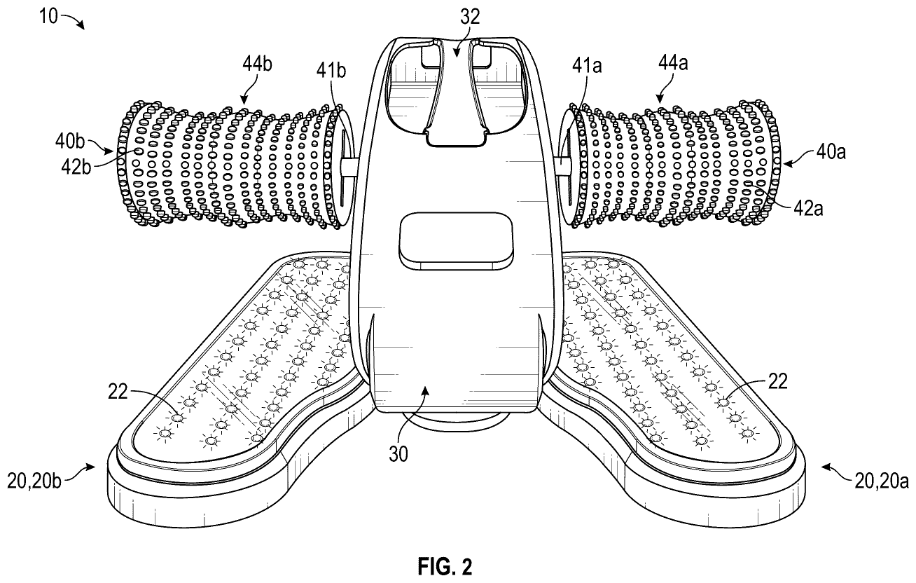

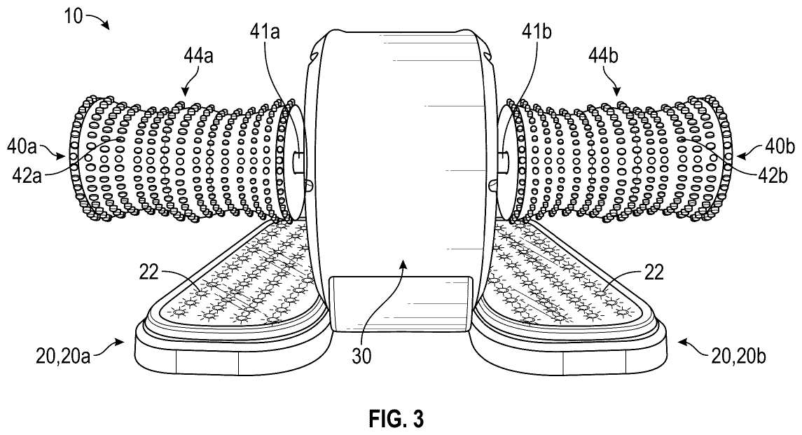

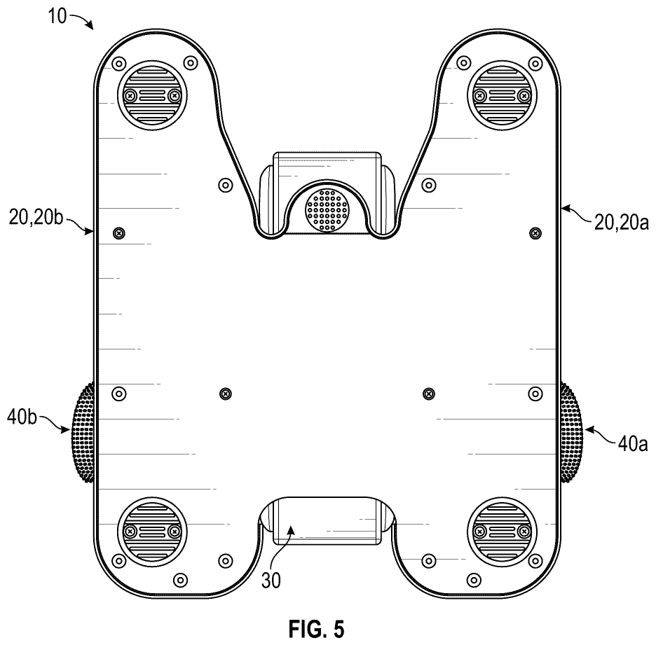

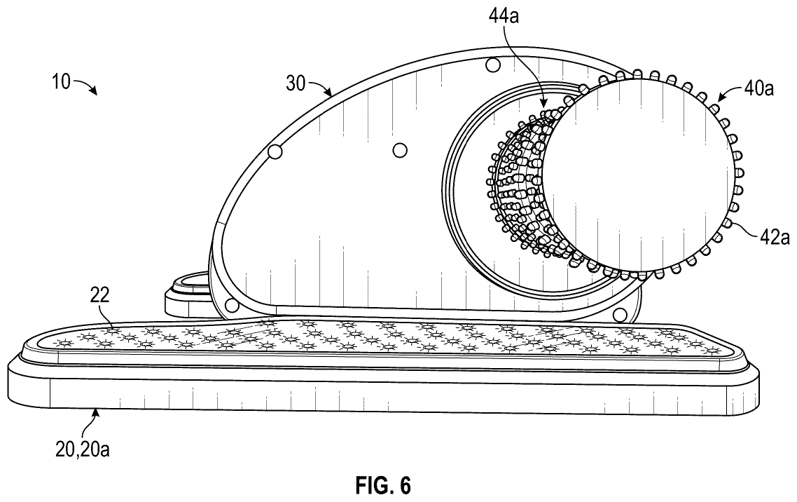

FIGS. 1-6 illustrate various views of an embodiment of the exercise and therapy device 10. In some embodiments, the exercise and therapy device 10 can include a base 20, a housing 30, a first roller 40a, a second roller 40b, a first shaft (e.g., without limitation, axle) 41a, and a second shaft (e.g., without limitation, axle) 41b. The first roller 40a and the second roller 40b are collectively referred to herein as the rollers 40. In some embodiments, the first roller 40a can include a contact surface (e.g., without limitation, outer surface) 44a and/or one or a plurality of surface features 42a. Similarly, in some embodiments, the second roller 40b can include a contact surface 44b (e.g., without limitation, outer surface) and/or one or a plurality of surface features 42b.

In some embodiments, the base 20 can rest on a support surface, such as the ground, to support the exercise and therapy device 10. In some embodiments, a top surface of the base 20 can be substantially planar. In some embodiments, the top surface of the base 20 can be substantially parallel to the support surface the base 20 rests upon. A user can place one or both feet on the base 20 to rest his or her feet and/or legs when not exercising. In some embodiments, a user can place one or both feet on a top surface of the base 20 such that the bottom or one or both feet contacts the top surface of the base 20.

In some embodiments, the base 20 can include first and second base portions 20a, 20b. In some embodiments, a top surface of the base portion 20a can be substantially planar. In some embodiments, a top surface of the base portion 20b can be substantially planar. In some embodiments, the top surfaces of the base portions 20a, 20b can be substantially parallel to each other. In some embodiments, the top surfaces of the base portions 20a, 20b can be substantially parallel to the support surface. In some embodiments, the top surfaces of the base portions 20a, 20b can be angled relative to the support surface. For example, the top surfaces of the base portions 20a, 20b can be angled toward a user such that a user's heels are lower than a user's toes when a user's feet are positioned on the base portions 20a, 20b. The base portions 20a, 20b can be positioned on opposite, lateral sides of the housing 30. For example, the base portion 20a can be positioned on a right side of the housing 30, and the base portion 20b can be positioned on a left side of the housing 30.

In some embodiments, the base portions 20a, 20b can have an approximately rectangular shape with rounded corners. In some embodiments, the first base portion 20a can include a first end and a second end. For example and without limitation, the first end of the first base portion 20a is a proximal end (closest to a front of the device and a seated user), and the second end of the first base portion 20a is a distal end (furthest from the front of the device and a seated user). In some embodiments, the second base portion 20b can include a first end and a second end. For example and without limitation, the first end of the second base portion 20b is a proximal end (closest to a front of the device and a seated user), and the second end of the second base portion 20b is a distal end (furthest from the front of the device and a seated user). In some embodiments, the proximal end of the base portions 20a, 20b can be narrower than the distal end of the base portions 20a, 20b. In some embodiments, the proximal end of the base portions 20a, 20b can be rounded. In some embodiments, the distal end of the base portions 20a, 20b can be rectangular with rounded corners. In some embodiments, the width of the base portions 20a, 20b can taper toward the proximal end of the base portions 20a, 20b such that the proximal ends of the base portions 20a, 20b are narrower than the distal ends of the base portions 20a, 20b.

In some embodiments, the first base portion 20a can include a first side and a second side. For example and without limitation, the first side of the first base portion 20a is a lateral side (furthest from the housing 30), and the second side of the first base portion 20a is a medial side (closest to the housing). In some embodiments, the second base portion 20b can include a first side and a second side. For example and without limitation, the first side of the second base portion 20b is a lateral side (furthest from the housing 30), and the second side of the second base portion 20b is a medial side (closest to the housing). In some embodiments, the lateral side of the first base portion 20a can be parallel or substantially parallel to the lateral side of the second base portion 20b. In some embodiments, a portion of the medial side of the first base portion 20a can angle toward the lateral side of the first base portion 20a proximate the proximal end of the first base portion 20a such that the width of the first base portion 20a tapers toward the proximal end of the first base portion 20a. In some embodiments, a portion of the medial side of the second base portion 20b can angle toward the lateral side of the second base portion 20b proximate the proximal end of the second base portion 20b such that the width of the second base portion 20b tapers toward the proximal end of the second base portion 20b. In some embodiments, the base portions 20a, 20b can be sized and/or shaped such that a user can position one foot on a top surface of each base portion 20a, 20b. For example, a user can position his or her left foot on base portion 20b such that the bottom of the user's left foot contacts a top surface of the base portion 20b. A user can position his or her right foot on base portion 20a such that the bottom of the user's right foot contacts a top surface of the base portion 20a.

In some embodiments, the exercise and therapy device 10 can include a plurality of light emitters 22. In some embodiments, the base 20 and/or the base portions 20a, 20b can include a transparent or semi-transparent top surface. The base 20 and/or the base portions 20a, 20b can include a plurality of light emitters 22. In some embodiments, the light emitters 22 can be positioned beneath the transparent or semi-transparent top surface of the base 20 and/or base portions 20a, 20b such that at least some of the light emitted from the light emitters 22 escapes from (e.g., without limitation, passes through) the top surface of the base 20 and/or the base portions 20a, 20b. In some embodiments, substantially all or at least a majority of the light emitted from the light emitters 22 passes through the top surface of the base 20 and/or the base portions 20a, 20b A user can place his or her feet on the top surface of the base 20 and/or the base portions 20a, 20b such that at least some of the light emitted from the light emitters 22 is received by the user's foot or feet. In some embodiments, substantially all or at least a majority of the light emitted from the light emitters 22 is received by the user's foot or feet.

In some embodiments, the device is configured (e.g., without limitation, without limitation, using one or more sensors such as pressure sensors) to determine when a user's foot is placed on the base 20 and/or the base portions 20a, 20b. In some embodiments, the device is selectively configured to activate or turn on one or a plurality of light emitters 22 when the user's foot is placed on the base 20 and/or the base portions 20a, 20b and to selectively deactivate or turn off the one or the plurality of light emitters 22 when the user's foot is removed from the base 20 and/or the base portions 20a, 20b. In this arrangement, the device can be configured to automatically activate or turn on the one or the plurality of light emitters 22 simply by placing the user's foot or feet on the base 20 and/or the base portions 20a, 20b and to deactivate or turn off the one or the plurality of light emitters 22 simply by removing the user's foot or feet from the base 20 and/or the base portions 20a, 20b. In any embodiments disclosed herein, the one or the plurality of light emitters 22 of the first and second base portions 20a, 20b can be independently activated (e.g., without limitation, the one or the plurality of light emitters of the first portion can be activated or deactivated independently of the one or the plurality of light emitters of the second portion, and vice versa).

In some embodiments, the light emitters 22 can emit light that promotes healing and/or therapeutic benefits to the user. In some embodiments, the light emitters 22 can emit light that is substantially red in color. In some embodiments, the light emitters 22 can be red light diodes. In some embodiments, the light emitters 22 emit light with a wavelength that is between about 600 nm to 850 nm. In some embodiments, the wavelength of the light emitted by the light emitters 22 is between approximately 600 nm and approximately 850 nm, for example, between approximately 650 nm and approximately 800 nm, between approximately 700 nm and approximately 750 nm, or any value or range between any of these values or ranges or any value or range bounded by any combination of these values, although values and ranges outside these values or ranges can be used in some cases. In some embodiments, the intensity of light emitted by the light emitters 22 can be adjusted to increase and/or decrease the light emitted. The light emitted by the light emitters 22 can reduce inflammation, reduce pain, increase muscle recovery, and/or increase ATP production. In some embodiments, the light emitters 22 can include a self-contained power source. In some embodiments, the self-contained power source of the light emitters 22 can be independently charged. In some embodiments, a plurality of the light emitters 22 can be positioned on or otherwise coupled with the roller 40a. In some embodiments, a plurality of the light emitters 22 can be positioned on or otherwise coupled with the roller 40b.

In some embodiments, the housing 30 can be coupled to the base 20 and/or the base portions 20a, 20b such that the housing 30 extends away from the base 20 and/or the base portions 20a, 20b. The housing 30 can house various electronic and/or mechanical components to shield the components and/or protect a user from injuring themselves on the components. A first shaft 41a and/or a second shaft 41b can be at least partially disposed within the housing 30. A portion of a first shaft 41a and/or a portion of a second shaft 41b can extend from the housing 30. In some embodiments, portions of the shafts 41a, 41b can extend from opposite, lateral sides of the housing 30 such that a portion of the first shaft 41a and a portion of the second shaft 41b extend from the sides of the housing 30 in substantially opposite directions. The shafts 41a, 41b can be oriented such that they are substantially parallel to the base 20. In some embodiments, the shafts 41a, 41b can be oriented such that they are substantially parallel to the ground when the base 20 contacts the ground. In some embodiments, the shafts 41a, 41b can be oriented at an angle to the base 20 such that the shafts 41a, 41b are angled with respect to the ground when the base 20 contacts the ground. The shafts 41a, 41b can be positioned above the base 20 such that there is a gap between the shafts 41a, 41b and the base 20.

In some embodiments, the first shaft 41a can be rotated in a forward or backward direction. In some embodiments, the second shaft 41b can be rotated in a forward or backward direction. In some embodiments, the first shaft 41a is rotatable independently of the second shaft 41b. In some embodiments, the second shaft 41b is rotatable independently of the first shaft 41a. In some embodiments, the shafts 41a, 41b can be disconnected or separate from each other such that each of the shafts 41a, 41b can be free to rotate independently of each other. For example, one of the shafts 41a, 41b can rotate while the other shaft 41a, 41b is stationary. For example, one of the shafts 41a, 41b can rotate in a first direction while the other shaft 41a, 41b rotates in a second, opposite direction. For example, one of the shafts 41a, 41b can rotate at a first speed while the other shaft 41a, 41b rotates at a second, different speed. In some embodiments, the shafts 41a, 41b can be coaxial such that the first shaft 41a and second shaft 41b can rotate about the same axis of rotation. In some embodiments, the shafts 41a, 41b can be arranged such that they are not collinear such that the first shaft 41a and the second shaft 41b can rotate about different axes of rotation. In some embodiments, the device 10 can be configured such that the shafts 41a, 41b rotate together and in unison.

In some embodiments, the rollers 40a, 40b can be positioned on opposite lateral sides of the housing 30. This can allow a user to comfortably place a first foot or leg, for example a right foot or leg, on the first roller 40a while positioning a second foot or leg, for example a left foot or leg, on the second roller 40b. In some embodiments, the rollers 40a, 40b can be coupled to the shafts 41a, 41b. In some embodiments, the first roller 40a can be coupled to the first shaft 41a such that the first roller 40a can rotate with the first shaft 41a at the same rotational velocity as the first shaft 41a and/or about the same axis of rotation as the first shaft 41a. In some embodiments, the first roller 40a can be coupled to the first shaft 41a such that a rotation of the first roller 40a causes an equal and simultaneous rotation of the first shaft 41a. In some embodiments, the shaft 41a can include a key or other insert element that can be fitted in a keyhole of the roller 40a such that the shaft 41a and the roller 40a rotate in unison. In some embodiments, the second roller 40b can be coupled to the second shaft 41b such that the second roller 40b can rotate with the second shaft 41b at the same rotational velocity as the second shaft 41b and/or about the same axis of rotation as the second shaft 41b. In some embodiments, the second roller 40b can be coupled to the second shaft 41b such that a rotation of the second roller 40b causes an equal and simultaneous rotation of the second shaft 41b. In some embodiments, the shaft 41b can include a key or other insert element that can be fitted in a keyhole of the roller 40b such that the shaft 41b and the roller 40b rotate in unison. In some embodiments, the first roller 40a and the second roller 40b can rotate about the same axis of rotation which can be defined by the shafts 41a, 41b.

In some embodiments, the first shaft 41a can be at least partially disposed within the first roller 40a, and/or the second shaft 41a can be at least partially disposed within the second roller 40b. In some embodiments, the first shaft 41a can at least partially extend through a central axis of the first roller 40a, and/or the second shaft 41b can at least partially extend through a central axis of the second roller 40b. In some embodiments, the first roller 40a can be connected to the first shaft 41a such that there is a gap between the first roller 40a and the housing 30, and/or the second roller 40b can be connected to the second shaft 41b such that there is a gap between the second roller 40b and the housing 30. The rollers 40a, 40b can be positioned such that there is a gap between the rollers 40a, 40b and the base 20. The rollers 40a, 40b can be oriented such that are substantially parallel to the base. In some embodiments, the rollers 40a, 40b can be oriented such that they are substantially parallel to the ground when the base 20 is in contact with the ground. In some embodiments, the rollers 40a, 40b can be oriented at an angle to the base such that the roller 40a, 40b are angled with respect to the ground when the base 20 contacts the ground.

In some embodiments, the first roller 40a and the second roller 40b can rotate independently of each other. For example, one of the rollers 40a, 40b can rotate while the other roller 40a, 40b is stationary. For example, one of the rollers 40a, 40b can rotate in a first direction while the other roller 40a, 40b rotates in a second, opposite direction. For example, one of the rollers 40a, 40b can rotate at a first speed while the other roller 40a, 40b rotates at a second, different speed. Permitting the rollers 40a, 40b to rotate independently of each other can permit a user more freedom when using the exercise and therapy device 10 by permitting the user to engage in independent, bilateral lower-body movements where each foot and/or leg can contact and/or rotate a different roller 40a, 40b at the same or different speeds, the same or different frequencies, and/or the same or different directions. This can improve lower body coordination, help equalize foot and/or leg strength, help recovery from injuries that disproportionately affect one side of the body, improve lower body-flexibility, and/or improve balance. In some embodiments, the device 10 can be configured such that the rollers 40a, 40b rotate in unison.

In some embodiments, the rollers 40a, 40b can be approximately cylindrical in shape. In some embodiments, the first roller 40a can include a first end and a second end. For example and without limitation, the first end of the first roller 40a is a proximal end (closest to the housing 30) and the second end of the first roller 40a is a distal end (furthest from the housing 30). In some embodiments, the second roller 40b can include a first end and a second end. For example and without limitation, the first end of the second roller 40b is a proximal end (closest to the housing 30) and the second end of the second roller 40b is a distal end (furthest from the housing 30). In some embodiments, the rollers 40a, 40b can be approximately cylindrical in shape with a diameter that is variable along a length of the roller 40a, 40b. For example, the proximal and distal ends of the roller 40a can have a first, maximum diameter while inner portions of the roller 40a can have diameters that are less than the maximum diameter. The roller 40a can have a minimum diameter at one or more locations between the proximal and distal ends of the roller 40a. In some embodiments, the diameter of the roller 40a at a point approximately half-way between the proximal and distal ends of the roller 40a can be greater than the minimum diameter of the roller 40a. The diameter of a portion of the roller 40a near a center point approximately halfway between the proximal and distal ends of the roller 40a can be greater than the diameter of portions of the roller 40a adjacent to the center point. In some embodiments, when traversing from the proximal and/or distal end of the roller 40a toward a middle of the roller 40a, the diameter of the roller 40a can initially decrease. In some embodiments, when traversing from the proximal and/or distal end of the roller 40a toward a middle of the roller 40a, the diameter of the roller 40a can increase when nearing the middle of the roller 40a. In some embodiments, the roller 40b can have a shape that is the same or substantially similar to the shape of the roller 40a. In some embodiments, the shape of the roller 40b can be different than the shape of the roller 40a. The variable-diameter, cylindrical shape of the roller 40a and/or roller 40b can massage and/or stimulate a user's feet and/or legs to increase user comfort, increase blood flow, increase nerve activation, and/or reduce pain. In some embodiments, the rollers 40a and/or 40b can be made of rubber and/or plastic.

The roller 40a can include a contact surface 44a, and/or the roller 40b can include a contact surface 44b. In some embodiments, the contact surface 44a can extend between the top and bottom ends of the roller 40a, and/or the contact surface 44b can extend between the top and bottom ends of the roller 40b. In some embodiments, the contact surface 44a and/or 44b can be rounded. In some embodiments, a user can place a foot and/or leg on the contact surface 44a of roller 40a or contact surface 44b of roller 40b. A user can move his or her foot and/or leg to exert a force on the contact surface 44a to rotate roller 40a or exert a force on the contact surface 44b to rotate roller 40b. When a user exerts a force on the contact surface 44a or 44b using his or her foot and/or leg, the contact surface 44a or 44b can exert a force on the user's foot and/or leg where the user's foot and/or leg contacts the contact surface 44a or 44b to massage the user's foot and/or leg. In some embodiments, as a user rotates the roller 40a or roller 40b, different portions of the contact surface 44a or 44b can contact different portions of the user's foot and/or leg such that different portions of the user's foot and/or leg are massaged by the contact surface 44a or 44b. In some embodiments, a user can place his or her other foot and/or leg on the contact surface 44a or 44b of the other roller 40a or 40b and move his or her other foot and/or leg in the manner described above to massage his or her other foot and/or leg. In some embodiments, a user can use one foot and/or leg to rotate one roller 40a or 40b to massage one foot and/or leg at a time. In some embodiments, a user can use both feet and/or legs to rotate both rollers 40a and 40b simultaneously with each foot and/or leg being positioned on a different roller 40a or 40b to massage both feet and/or legs at the same time. In some embodiments, a user can contact and/or rotate the rollers 40a and/or 40b using a body part other than a leg or foot such as an arm and/or a hand to massage that body part. In some embodiments, the contact surfaces 44a and/or 44b can be made of a material with a high coefficient of friction such that a user's feet are less prone to sliding when rotating the rollers 40a and/or 40b. In some embodiments, the contact surfaces 44a and/or 44b can be made of rubber and/or plastic. In some embodiments, the contact surfaces 44a, 44b can be a different material than the rollers 40a, 40b. In some embodiments, the contact surfaces 44a, 44b can be a sleeve and/or tube that can be fitted around the rollers 40a, 40b.

In some embodiments, the first roller 40a can include surface features 42a, and/or the second roller 40b can include surface features 42b. In some embodiments, the surface features 42a can be arranged on the contact surface 44a. In some embodiments, the surface features 42b can be arranged on the contact surface 44b. In some embodiments, the surface features 42a, 42b can be projections, nubs, bumps, and/or recesses. In some embodiments, surface features 42a can be a plurality of projections extending outwardly from the contact surface 44a of the first roller 40a. In some embodiments, the surface features 42b can be a plurality of projections extending outwardly from the contact surface 44b of the second roller 40b. The surface features 42a and/or 42b can increase the stimulation to a user's feet and/or legs when the user's feet and/or legs are in contact with the contact surfaces 44a and/or 44b. In some embodiments, the surface features 42a and/or 42b can increase the pressure exerted on portions of a user's feet and/or legs by decreasing the surface area of the contact surface 44a and/or 44b that contacts a user's feet and/or legs which can increase blood circulation, reduce pain, stimulate nerves, stimulate key reflexology points, and improve user comfort during use of the exercise and therapy device 10. This can encourage a user to continue exercising by making the exercise experience more enjoyable. In some embodiments, the surface features 42a and/or 42b can rotate as the rollers 40a and/or 40b rotate such that the surface features 42a and/or 42b can contact different portions of a user's feet and/or legs.

In some embodiments, the surface features 42 and/or 42b can be arranged on the contact surfaces 44a and/or 44b in a grid-like pattern. In some embodiments, the surface features 42a and/or 42b can be arranged on the contact surfaces 44a and/or 44b such that the surface features 42a and/or 42b can contact and/or stimulate specific reflexology points in a user's foot. In some embodiments, the surface features 42a and/or 42b can be circular, ovoid, rectangular, hexagonal, or any other appropriate shape. In some embodiments, the surface features 42a and/or 42b can include a plurality of shapes such that different portions of the contact surfaces 44a and/or 44b can include surface features 42a and/or 42b with different shapes and/or sizes. In some embodiments, the surface features 42a and/or 42b can be made of rubber and/or plastic. In some embodiments, the surface features 42 can be projections that have a length that is between about ⅛ in. to 1 in. In some embodiments, the length of the projections is between approximately ⅛ in. and approximately 1 in., for example, between approximately ¼ in. and ⅞ in., between approximately ⅜ in. and ¾ in., between approximately ½ in. and ⅝ in., or any value or range between any of these values or ranges or any value or range bounded by any combination of these values, although values and ranges outside these values or ranges can be used in some cases. In some embodiments, the surface features 42a and/or 42b can include a textured surface to increase grip for a user rotating the roller 40a and/or 40b.

In some embodiments, the exercise and therapy device 10 can include a plurality of interchangeable rollers 40a, 40b with different contact surfaces 44a, 44b, surface features 42a, 42b, weights, sizes, and/or shapes. In some embodiments, the interchangeable rollers 40a, 40b can be made of different materials. In some embodiments, the rollers 40a, 40b can be removably connected to the shafts 41a, 41b such that a user can detach the rollers 40a, 40b from the shafts 41a, 41b and attach a different set of rollers 40a, 40b with different sizes and/or features. In some embodiments, the roller 40a attached to the shaft 41a can have different features than the roller 40b attached to shaft 41b. In some embodiments, the exercise and therapy device 10 can include a plurality of interchangeable contact surfaces 44a, 44b with different surface features 42a, 42b, sizes, and/or shapes. In some embodiments, the contact surfaces 44a, 44b can be made of different materials. In some embodiments, the contact surfaces can be removably attached to the rollers 40a, 40b such that a user can detach the contact surfaces 44a, 44b from the rollers 40a, 40b and attach a different set of contact surfaces 44a, 44b. In some embodiments, the contact surface 44a connected to the roller 40a can have different features than the contact surface 44b connected to the roller 40b. Providing the option to use different interchangeable rollers 40a, 40b and/or different interchangeable contact surfaces 44a, 44b can allow a user to customize the exercise and therapy device 10 to better fit his or her individual needs.

In some embodiments, the force required to rotate the rollers 40a, 40b of the exercise and therapy device 10 can be adjusted. In some embodiments, the force required to rotate each roller 40a, 40b can be adjusted by increasing or decreasing the resistance acting against the rotation of each roller 40a, 40b. The resistance acting against the rotation of each roller 40a, 40b can resist the rotation of the roller 40a, 40b regardless of the directionality of rotation of the roller 40a, 40b. In some embodiments, a first resistance can selectively impede the rotation of the first roller 40a. In some embodiments, a second resistance can selectively impede the rotation of the second roller 40b. Increasing the force required to rotate the rollers 40a, 40b can increase the intensity of the workout, increasing heart rate, improving circulation and cardiovascular health, facilitating rehabilitation from injuries, and/or promoting muscle growth. Decreasing the force required to rotate rollers 40a, 40b can decrease the intensity of the workout which some user's may prefer depending on his or her strength and conditioning. In some embodiments, the resistance acting against the rotation of each roller 40a, 40b can be independently adjusted such that the force required to rotate each roller 40a, 40b can be different which can allow a user to selectively increase or decrease the difficulty of exercise for his or her left and right feet and/or legs independently. This can be advantageous for people recovering from strokes or injuries that disproportionately impact one side of his or her body. In some embodiments, a user can adjust the resistance in real-time such that the resistance acting against rotation of each roller 40a, 40b can be adjusted before, during, and/or after an exercise session which can allow a user to change the difficulty of his or her workout during the workout.

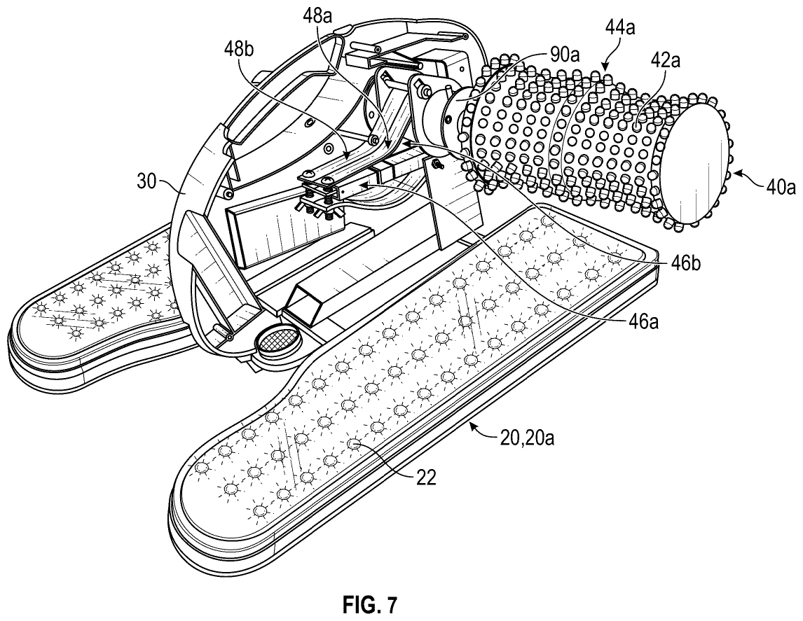

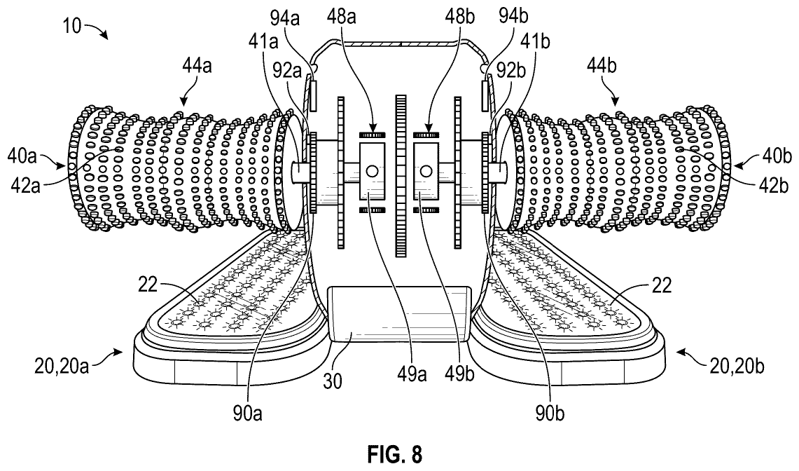

FIG. 7 illustrates an isometric view of the exercise and therapy device 10 with a portion of the housing 30 removed. FIG. 8 illustrates a rear view of the exercise and therapy device 10 with a portion of the housing 30 removed such that certain internal components are visible. In some embodiments, the resistance acting against the rotation of the rollers 40a, 40b can be modified by adjusting the resistance acting against the rotation of respective, connected shaft 41a, 41b. In some embodiments, the resistance acting against the rotation of each shaft 41a, 41b can resist the rotation of the shaft 41a, 41b regardless of the directionality of rotation of the shaft 41a, 41b. In some embodiments, the resistance acting against rotation of the shafts 41a, 41b can be adjusted by increasing or decreasing a frictional force that can resist rotation of the shafts 41a, 41b. In some embodiments, the frictional force can resist rotation of the shafts 41a, 41b regardless of the directionality of rotation of the shafts 41a, 41b.

In some embodiments, friction members 48a, 48b can apply a frictional force to the shafts 41a, 41b. For example, the friction member 48a can apply a frictional force to shaft 41a, and/or the friction member 48b can apply a frictional force to shaft 41b. The frictional force exerted by the friction members 48a, 48b can be adjusted to increase or decrease the force required to rotate the shafts 41a, 41b. In some embodiments, the one or more friction members 48a, 48b can be belts. In some embodiments, the first friction member 48a can at least partially surround the first shaft 41a, and/or the second friction member 48b can at least partially surround the second shaft 41b. In some embodiments, the friction member 48a can contact the shaft 41a such that a frictional force is created between the friction member 48a and the shaft 41a, and/or the friction member 48b can contact the shaft 41b such that a frictional force is created between the friction member 48b and the shaft 41b. In some embodiments, the friction members 48a, 48b do not directly contact the shafts 41a, 41b.

As shown in FIG. 8, in some embodiments, the friction members 48a, 48b can apply a frictional force to collars 49a, 49b. For example, the friction member 48a can apply a frictional force to collar 49a, and/or the friction member 48b can apply a frictional force to collar 49b. The frictional force between the friction members 48a, 48b and the collars 49a, 49b can increase the force required to rotate the collars 49a, 49b. In some embodiments, the first friction member 48a can at least partially surround the collar 49a, and/or the second friction member 48b can at least partially surround the collar 49b. In some embodiments, the friction member 48a can contact the collar 49a such that a frictional force is created between the friction member 48a and the collar 49a, and/or the friction member 48b can contact the collar 49b such that a frictional force is created between the friction member 48b and the collar 49b. In some embodiments, the shaft 41a can be rotatably coupled to the collar 49a, and/or the shaft 41b can be rotatably coupled to the collar 49b such that the frictional force impeding the rotation of the collars 49a, 49b can also impede rotation of the shafts 41a, 41b. In some embodiments, the shaft 41a can be at least partially disposed in the collar 49a, and/or the shaft 41b can be at least partially disposed in the collar 49b. In some embodiments, the collar 49a can surround the shaft 41a such that the collar 49a contacts the shaft 41a, and/or the collar 49b can surround the shaft 41b such that the collar 49b contacts the shaft 41b.

In some embodiments, the tension in the friction members 48a, 48b can be increased or decreased to increase or decrease the frictional force acting on the shafts 41a, 41b. For example, when the tension in the friction members 48a, 48b is increased, the normal force exerted by the friction members 48a, 48b on the collars 49a, 49b and/or the shafts 41a, 41b can increase such that the frictional force exerted by the friction members 48a, 48b can increase. For example, when the tension in the friction members 48a, 48b is decreased, the normal force exerted by the friction members 48a, 48b on the collars 49a, 49b and/or the shafts 41a, 41b can decrease such that the frictional force exerted by the friction members 48a, 48b can decrease. In some embodiments, the friction members 48a, 48b can be made of nylon. In some embodiments, the friction members 48a, 48b can be made of a mesh or webbing. In some embodiments, the friction members 48a, 48b can be made of a material with a high coefficient of friction or contain surface features to increase the coefficient of friction. Increasing the coefficient of friction can increase the maximum frictional force exerted by the friction members 48a, 48b, which can increase the force required to rotate the shafts 41a, 41b and the rollers 40a, 40b. In some embodiments, the friction members 48a, 48b can be stationary relative to the shafts 41a, 41b.

As shown in FIG. 7, in some embodiments, the exercise and therapy device 10 can include a first actuator 46a and/or a second actuator 46b. In some embodiments, the tension of the friction members 48a, 48b can be adjusted by the actuators 46a, 46b. In some embodiments, the actuators 46a, 46b can be linear actuators. In some embodiments, the first friction member 48a can be coupled to the first actuator 46a. In some embodiments, the first actuator 46a can be configured to increase and/or decrease the tension in the first friction member 48a. In some embodiments, the first actuator 46a can include an arm configured to extend and/or retract. In some embodiments, the first friction member 48a can be coupled to the arm of the first actuator 46a such that the tension in the first friction member 48a increases when the arm extends, and/or the tension in the first friction member 48a decreases when the arm retracts. In some embodiments, the first actuator 46a can be at least partially disposed within the first friction member 48a. In some embodiments, the first actuator 46a can be positioned such that, when the first actuator 46a extends, the arm of the first actuator 46a moves away from the first shaft 41a. In some embodiments, the first actuator 46a can be positioned such that, when the first actuator 46a retracts, the arm of the first actuator 46a moves toward the first shaft 41a. In some embodiments, the first friction member 48a can be coupled to the arm of the first actuator 46a such that the first friction member 48a is pulled when the arm of the first actuator 46a extends, increasing the tension in the first friction member 48a and increasing the frictional force exerted on the first shaft 41a. In some embodiments, the first friction member 48a can be coupled to the arm of the first actuator 46a such that the first friction member 48a is relaxed when the arm of the first actuator 46a retracts, decreasing the tension in the first friction member 48a and increasing the frictional force exerted on the first shaft 41a.

In some embodiments, the second friction member 48b can be coupled to the second actuator 46b. In some embodiments, the second actuator 46b can be configured to increase and/or decrease the tension in the second friction member 48b. In some embodiments, the second actuator 46b can include an arm configured to extend and/or retract. In some embodiments, the second friction member 48b can be coupled to the arm of the second actuator 46b such that the tension in the second friction member 48b increases when the arm extends, and/or the tension in the second friction member 48b decreases when the arm retracts. In some embodiments, the second actuator 46b can be at least partially disposed within the second friction member 48b. In some embodiments, the second actuator 46b can be positioned such that, when the second actuator 46b extends, the arm of the second actuator 46b moves away from the second shaft 41b. In some embodiments, the second actuator 46b can be positioned such that, when the second actuator 46b retracts, the arm of the second actuator 46b moves toward the second shaft 41b. In some embodiments, the second friction member 48b can be coupled to the arm of the second actuator 46b such that the second friction member 48b is pulled when the arm of the second actuator 46b extends, increasing the tension in the second friction member 48b and increasing the frictional force exerted on the second shaft 41b. In some embodiments, the second friction member 48b can be coupled to the arm of the second actuator 46b such that the second friction member 48b is relaxed when the arm of the second actuator 46b retracts, decreasing the tension in the second friction member 48b and decreasing the frictional force exerted on the second shaft 41b.

In some embodiments, the exercise and therapy device 10 can utilize alternative methods to independently adjust the force required to rotate each of the rollers 40a, 40b. For example, the exercise and therapy device 10 can include one or more brakes such as disk brakes, inductive brakes, rim brakes, hydraulic brakes, eddy current brakes, etc. to resist rotation of the shafts 41a, 41b and/or the rollers 40a, 40b. In some embodiments, the force applied by the brakes can resist rotation of the shafts 41a, 41b and/or the rollers 40a, 40b. In some embodiments, the force applied by the brakes can be independently adjusted such that the force required to rotate each shaft 41a, 41b and/or each roller 40a, 40b can be independently adjusted.

In some embodiments, a user can adjust the resistance acting against rotation of each roller 40a, 40b by interacting with a remote 80 and/or controls located on the exercise and therapy device 10 to increase or decrease the force required to rotate each roller 40a, 40b. In some embodiments, the remote 80 and/or controls can be configured to extend and/or retract the arms of the actuators 46a, 46b to increase and/or decrease the tension of the friction members 48a, 48b, which can increase and/or decrease the friction acting on the shafts 41a, 41b and/or the resistance acting against rotation of the rollers 40a, 40b.

In some embodiments, the exercise and therapy device can measure and/or calculate information relating to the rotation of the rollers 40a, 40b and/or the rotation of the shafts 41a, 41b such as the total number of rotations, the number of rotations per a time period, the speed of rotation, etc. As shown in FIG. 8, in some embodiments, the shaft 41a can be rotatably coupled to a flange 90a such that the flange 90a rotates at the same rotational velocity as the shaft 41a, and/or the shaft 41b can be rotatably coupled to a flange 90b such that the flange 90b rotates at the same rotational velocity as the shaft 41b (see FIG. 8). In some embodiments, the flange 90a can be connected to shaft 41a within the housing 30, and/or the flange 90b can be connected to the shaft 41b within the housing 30. In some embodiments, a magnet 92a can be mounted on the flange 90a such that the magnet 92a rotates at the same rotational velocity as the flange 90a and/or the shaft 41a, and/or a magnet 92b can be mounted on the flange 90b such that the magnet 92b rotates at the same rotational velocity as the flange 90b and/or the shaft 41b (see FIG. 8).

In some embodiments, the exercise and therapy device 10 can include one or more sensors 94a, 94b that can detect changes in a magnetic field. In some embodiments, the sensor 94a can be configured to emit a signal when the first shaft 41a completes a rotation. In some embodiments, the sensor 94b can be configured to emit a signal when the second shaft 41b completes a rotation. In some embodiments, the sensor 94a can emit a signal when the magnet 92a passes within a predetermined distance of the sensor 94a. In some embodiments, the sensor 94b can emit a signal when the magnet 92b passes within a predetermined distance of the sensor 94b. In some embodiments, the sensor 94a can be positioned above the magnet 92a. In some embodiments, as the magnet 92a rotates with the shaft 41a and/or the flange 90a, the distance between the magnet 92a and the sensor 94a can change. The sensor 94a can be configured to emit a signal when the distance between the magnet 92a and the sensor 94a is at a minimum (i.e., when the magnet 92a passes by the sensor 94a) such that the sensor 94a emits a signal once per revolution of the shaft 41a. In some embodiments, the sensor 94b can be positioned above the magnet 92b. In some embodiments, as the magnet 92b rotates with the shaft 41b and/or the flange 90b, the distance between the magnet 92b and the sensor 94b can change. The sensor 94b can be configured to emit a signal when the distance between the magnet 92b and the sensor 94b is at a minimum (i.e., when the magnet 92b passes by the sensor 94b) such that the sensor 94b emits a signal once per revolution of the shaft 41b. In some embodiments, the exercise and therapy device 10 can receive and utilize the signals emitted by the sensors 94a, 94b to calculate and/or record information regarding the rotation of the shafts 41a, 41b and the rollers 40a, 40b such as the total number of rotations in an exercise session, the number of rotations per a time period, the speed of rotation, etc. In some embodiments, the exercise and therapy device 10 can display some or all of this information to the user, for example, through one or more displays 50.

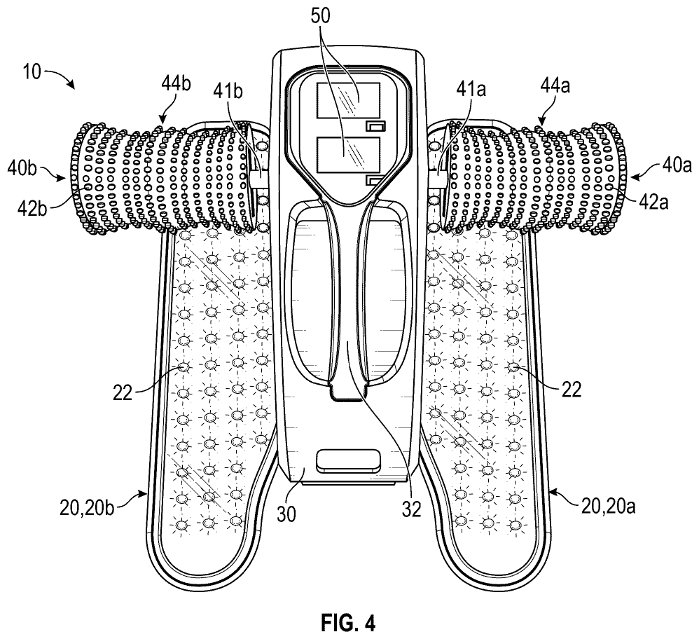

As shown in FIGS. 1 and 4, in some embodiments, the exercise and therapy device can include one or more display(s) 50. In some embodiments, the one or more display(s) 50 can show information relating to the rotation of the rollers 40a, 40b and/or the rotation of the shafts 41a, 41b such as the total number of rotations, the number of rotations per a time period, the speed of rotation, etc. In some embodiments, the one or more display(s) can additionally or alternatively show information such as estimated calories burned and/or the time remaining in an exercise session. In some embodiments the one or more display(s) can additionally or alternatively display a first numerical value representing the resistance acting against the rotation of the first roller and/or display a second numerical value representing the resistance acting against the rotation of the second roller. In some embodiments, the one or more display(s) 50 can be positioned on a top surface of the housing 30 such that a user can easily view the one or more display(s) 50. Displaying exercise information to the user can gamify the exercise experience by providing real time feedback and progress indicators which can increase a user's motivation to continue exercising. In some embodiments, the exercise and therapy device 10 can include two displays 50 such that one display 50 can display information relating to the first roller 40a, and a second display 50 can display information relating to the second roller 40b. For example, one display 50 can display the number of rotations of the first roller 40a while the other display 50 can display the number of rotations of the second roller 40b. In some embodiments, the exercise and therapy device can include a singular display 50 that can display information relating to one or both rollers 40a, 40b. In some embodiments, the one or more display(s) 50 can be switched between a plurality of modes that can display different information and/or combinations of information to a user about the exercise and therapy device 10 and/or his or her current exercise session.

As shown in FIGS. 1, 2, and 4, in some embodiments, the exercise and therapy device 10 can include a handle 32 configured to be gripped by a user to allow a user to pick up and/or move the device 10. In some embodiments, the handle 32 can be connected to the housing 30. In some embodiments, the handle 32 can be positioned proximate a top surface of the housing 30 such that the handle 32 is positioned above the support surface. This can increase the ease with which a user can pick up the exercise and therapy device 10 by allowing a user to grab the handle 32 without having to reach down to the support surface.

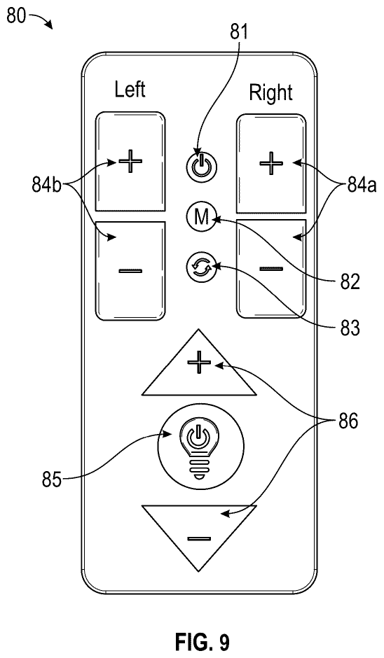

FIG. 9 illustrates a top view of an embodiment of a remote 80 that can be used with any embodiments of the exercise device 10 disclosed herein. In some embodiments, a user can interact with the remote 80 to control and/or affect various aspects of the exercise and therapy device 10 such as powering the device 10 on and/or off, changing the resistance acting against rotation of the rollers 40a, 40b, changing the information shown on the display(s) 50, resetting the exercise and therapy device 10, turning the light emitters 22 on and/or off, increasing and/or decreasing the intensity of the light emitters 22, etc. The remote 80 can include a plurality of inputs (e.g., without limitation, buttons, touch screens, knobs, switches, levers, etc.) that a user can engage with to control and/or affect various aspects of the exercise and therapy device 10. In some embodiments, the remote 80 can include an input 81 which can be interacted with to power the exercise and therapy device 10 on and/or off. In some embodiments, the remote 80 can include an input 82 which can be interacted with to change the mode of the displays such that a user can change the information displayed by the display(s) 50. In some embodiments, the remote 80 can include an input 83 which can be interacted with to reset the exercise and therapy device 10. Resetting the exercise and therapy device 10 can stop operation of the exercise and therapy device 10, restart the current exercise session on the exercise and therapy device 10, erase data from the current exercise session from the exercise and therapy device 10, return the resistance of each roller 40a, 40b to a baseline or predetermined value, return the intensity of the light emitters 22 to a baseline or predetermined value, etc. In some embodiments, the remote 80 can include input(s) 84a that can be interacted with to increase and/or decrease the resistance acting against rotation of first roller 40a. In some embodiments, the remote 80 can include input(s) 84b which can be interacted with to increase and/or decrease the resistance acting against rotation of the second roller 40b. In some embodiments, the remote can include inputs 85, 86 which can be interacted with by a user to turn the light emitters 22 on and off and/or change the intensity of the light emitted by the light emitters 22. In some embodiments, any combination or controls and/or functions that can be performed by the remote 80 can be performed by the exercise and therapy device 10. For example, any of the inputs located on the remote 80 can additionally or alternatively be located on the exercise and therapy device 10.

In some embodiments, the display(s) 50 of the exercise and therapy device 10 can include one or more user inputs which can be similar or identical to any of the user inputs 81, 82, 83, 84a, 84b, 85, and/or 86 of the remote 80. For example, the display 50 can include a touch screen that can be interacted with to affect operation of the exercise and therapy device 10. A user can interact with the display(s) 50 to control and/or affect various aspects of the exercise and therapy device 10 in a similar or identical manner as described with respect to the remote 80. In some embodiments, operation of the exercise and therapy device 10 can be controlled via one or more remote devices (e.g., without limitations, smartphones, computers, laptops, etc.) in a similar or identical manner as described with respect to the remote 80. For example, the exercise and therapy device can wirelessly connect to the remote device (e.g., without limitation, via Bluetooth).

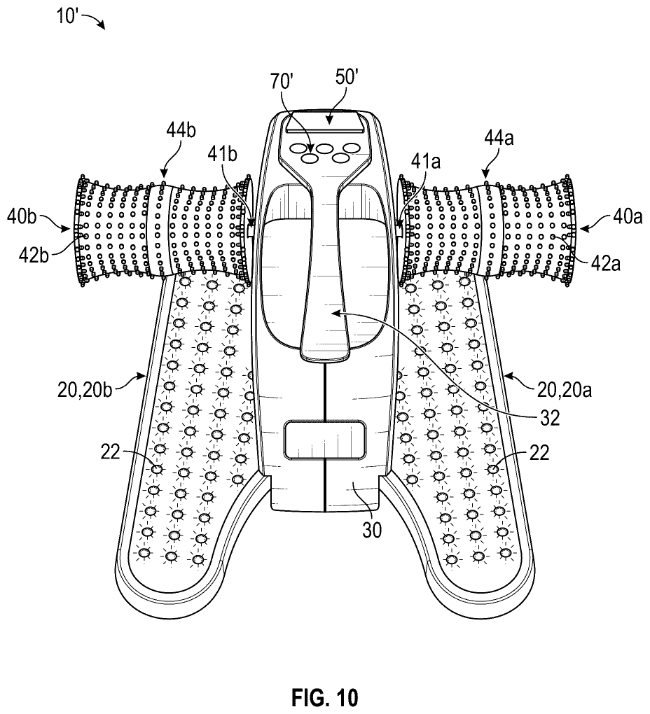

FIG. 10 illustrates a top perspective view of another embodiment of an exercise and therapy device 10′. The exercise and therapy device 10′ can be substantially similar or identical to the exercise and therapy device 10 as indicated by the use of common reference numbers, except with regard to the display 50′ and controls 70′. In some embodiments, the display 50′ can display information similar or identical to the display 50. In some embodiments, the display 50′ can include a singular screen. In some embodiments, the controls 70′ can control and/or affect various aspects of the exercise and therapy device 10 such as powering the device 10 on and/or off, changing the resistance of the rollers 40a, 40b, changing the information shown on the display(s) 50, resetting the exercise and therapy device 10, turning the light emitters 22 on and/or off, increasing and/or decreasing the intensity of the light emitters 22, etc. In some embodiments, the controls 70′ can include a plurality of inputs similar or identical to the inputs of the remote 80.

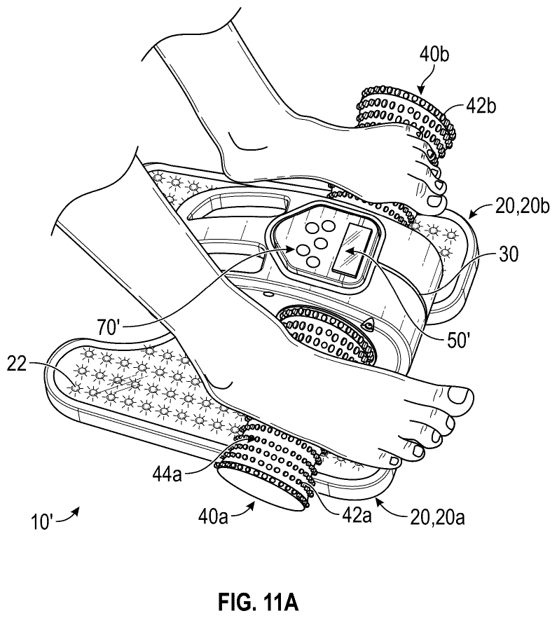

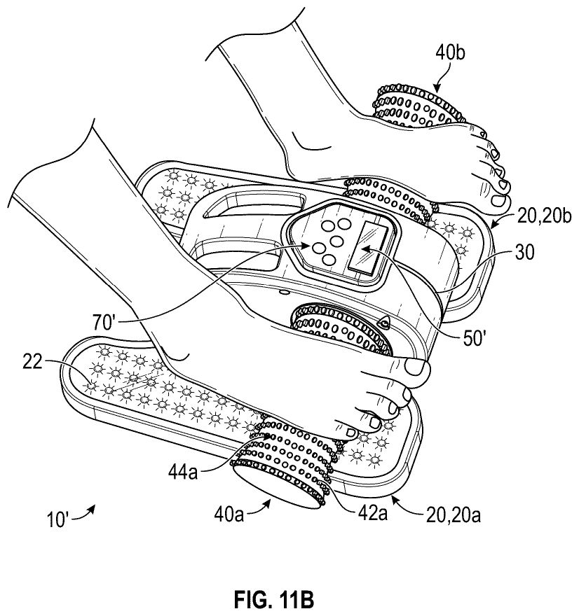

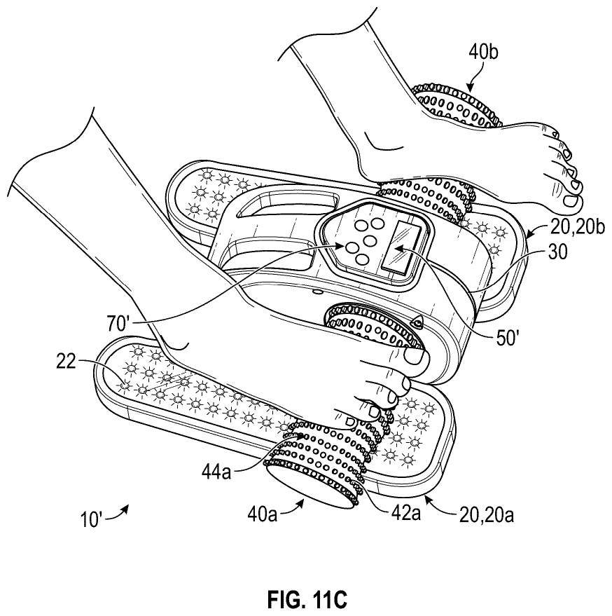

FIGS. 11A-11C illustrate the exercise and therapy device 10′ during operation. Operation of the exercise and therapy device 10′ can be substantially similar or identical to operation of the exercise and therapy device 10 and/or any of the other example exercise and therapy devices disclosed herein. Any of the benefits described from use of the exercise and therapy device 10′ can also apply to the exercise and therapy device 10 and/or any of the other example exercise and therapy devices disclosed herein.

In some embodiments, a user can place a foot on the contact surface 44a of the roller 40a or the contact surface 44b of the roller 40b such that a bottom surface of the user's foot contacts the contact surface 44a or 44b. For example, a user's left foot can contact either the roller 40a or 40b, a user's right foot can contact either the roller 40a or 40b, both the left and the right foot can contact the rollers 40a, 40b simultaneously, and/or one foot can contact one roller 40a or 40b at a time. A user can place a foot on the contact surface 44a or 44b at any angle relative to the ground to accommodate user preference and increase user comfort while using the exercise and therapy device 10′. For example, a user can place a foot on the contact surface 44a or 44b such that the bottom of the user's foot is substantially parallel to the ground, a user can place a foot on the contact surface 44a or 44b such that the bottom of the user's foot is substantially perpendicular to the ground, or a user can place a foot on the contact surface 44a or 44b such that the bottom of the user's foot forms an angle between 0 degrees and 180 degrees with the ground.

A user can move his or her foot forward and backward while the foot contacts the contact surface 44a or 44b to exert a force on the roller 40a or 40b which can rotate the roller 40a or 40b forward and backward to exercise the user's foot and/or leg, which can improve circulation, facilitate muscle growth, increase strength, increase balance, increase dexterity, and/or improve rehabilitation from an injury. In some embodiments, a user can place one foot on each roller 40a, 40b simultaneously and move both feet forward and backward while each foot contacts a different contact surface 44a, 44b such that both rollers 40a, 40b are rotated forward and backward. In some embodiments, the user can articulate one or both legs toward his or her body in a flexion motion to rotate the roller 40a and/or 40b toward his or her body. The user can articulate one or both legs away from his or her body in an extension motion to rotate the roller 40a and/or 40b away from his or her body. The user can alternate between this flexion and extension motion to alternate rotating the roller 40a and/or 40b away from and toward the body. In some embodiments, the user can move both feet and/or legs in the same direction simultaneously. In some embodiments, the user can move his or her feet and/or legs in opposite directions such that one leg is articulating in a flexion motion while the other leg is articulating in an extension motion such that the rollers 40a and 40b rotate in opposite directions simultaneously. Articulating the user's legs in the same direction or in opposite directions simultaneously can enhance flexibility, coordination, strength, and/or balance of the user. Permitting a user to rotate each roller 40a, 40b independently by moving his or her legs independently can permit independent bilateral lower-body movement which can promote neuroplasticity, prevent or diminish muscular atrophy, aid in diabetes treatment, and improve circulation to the lower body.

As the user moves his or her foot to rotate the roller 40a or roller 40b, different portions of the contact surface 44a or 44b and/or the surface features 42a or 42b can contact different portions of the user's foot, massaging the foot. For example, a user can initially place his or her foot so that his or her toes are in contact with the contact surface 44a or 44b. The user can then move his or her foot forward away from his or her body such that the roller 40a or 40b rotates forward until the user's heel is in contact with the contact surface 44a or 44b. The user can then move his or her foot backward toward his or her body such that the roller 40a or 40b rotates backward until the user's toes are in contact with the contact surface 44a or 44b. In this manner, any portion of the bottom of the user's foot between and/or including his or her toes and heel can contact the contact surface 44a or 44b such that any portion of the bottom of the user's foot can be massaged by the contact surface 44a or 44b and/or surface features 42a or 42b. This can increase blood circulation, reduce pain, decrease muscle tension, stimulate nerves, stimulate key reflexology points, and/or improve user comfort during use of the exercise and therapy device 10′. Additionally or alternatively, it can aid in the treatment of neuropathy, plantar fasciitis, diabetes, circulatory dysfunction, and/or muscular atrophy.

A user can adjust the resistance of the roller 40a and/or the roller 40b during operation of the exercise and therapy device 10′ or any other example exercise and therapy device disclosed herein as described above with reference to FIGS. 7-8. A user can adjust the resistance acting against the rotation of the roller 40a and/or roller 40b to adjust the force required to rotate the roller 40a and/or 40b. This can allow a user to adjust the level of difficulty of exercise for each foot and/or leg individually which can help equalize the strength or dexterity of both feet and/or legs, help recover from an injury to one foot and/or leg, and/or help during the recovery from a stroke.

In some embodiments, a user can place one or more legs on the contact surfaces 44a or 44b of the rollers 40a or 40b in addition to or instead of a foot to exercise and/or massage the user's leg(s). For example, a user can position his or her leg such that the back of a user's calf or thigh contacts the contact surface 44a or 44b. A user can move his or her leg in a similar manner to that described above to exercise and/or massage his or her calf or thigh using the contact surface 44a or 44b, surface features 42a or 42b, and/or roller 40a or 40b.

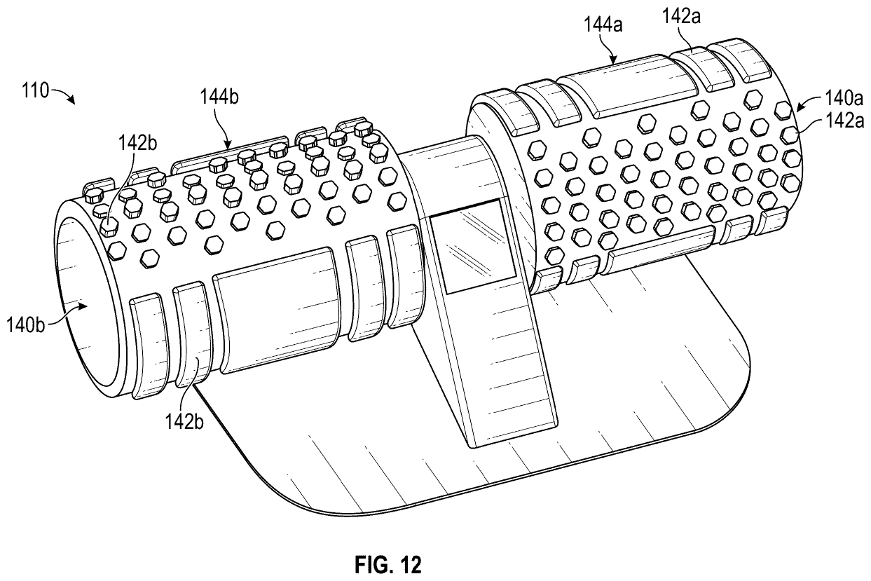

FIG. 12 illustrates a front, top perspective view of another embodiment of an exercise and therapy device 110 which may include similar structural and/or operational features to any of the other example exercise and therapy devices disclosed herein. The exercise and therapy device 110 can include rollers 140a, 140b, contact surfaces 144a, 144b, and/or surface features 142a, 142b. The rollers 140a, 140b can be substantially cylindrical in shape. The rollers 140a, 140b can be hollow. The roller 140a can include contact surface 144a, and/or the roller 140b can include contact surface 144b. The contact surfaces 144a, 144b can include surface features 142a, 142b. The surface features 142a, 142b can include a plurality of projections. The surface features 142a, 142b can have a shape that is hexagonal, rectangular, circular, or any other appropriate shape. In some embodiments, different portions of the contact surfaces 144a, 144b can include surface features 142a, 142b with different shapes. For example, one portion of the contact surface 144a, 144b can include hexagonal surface features 142a, 142b while other portions of the contact surfaces 144a, 144b can include rectangular surface features 142a, 142b.

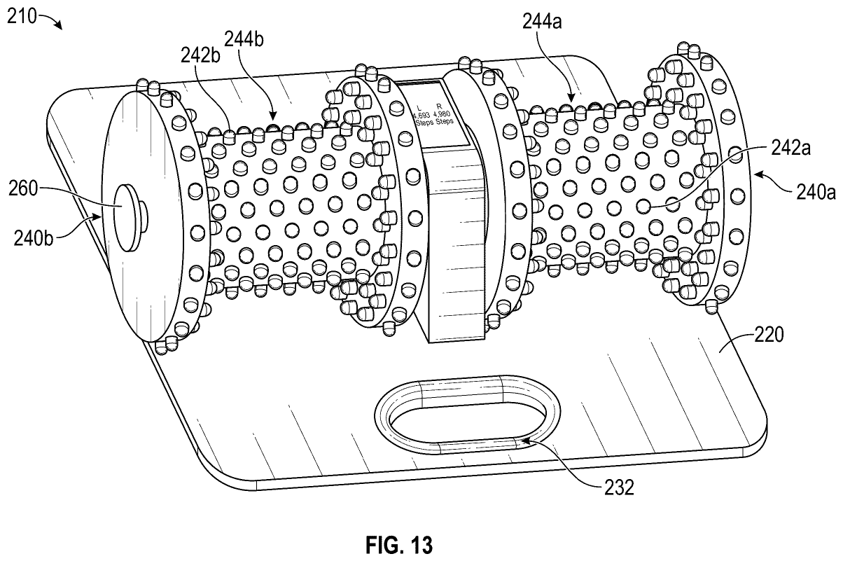

FIG. 13 illustrates a front, top perspective view of another embodiment of an exercise and therapy device 210 which may include similar structural and/or operational features to any of the other example exercise and therapy devices disclosed herein. The exercise and therapy device 210 can include rollers 240a, 240b, contact surfaces 244a, 244b, surface features 242a, 242b, controls 260, a base 220, and/or handle 232. The rollers 240a, 240b can be approximately cylindrical in shape with top and bottom ends that have a greater diameter than inner portions of the rollers 240a, 240b. The roller 240a can include contact surface 244a, and/or the roller 240b can include contact surface 244b. The contact surfaces 244a, 244b can include surface features 242a, 242b. The surface features 242a, 242b can include a plurality of projections arranged on the contact surfaces 244a, 244b. In some embodiments, a portion of the surface features 242a, 242b can extend radially from the rollers 240a, 240b. In some embodiments, a portion of the surface features 242a, 242b can extend along a longitudinal axis of the rollers 240a, 240b. The controls 260 can be interacted with to adjust the resistance acting against rotation of the rollers 240a, 240b. The controls 260 can be knobs. The controls 260 can be positioned on the rollers 240a, 240b. The handle 232 can be positioned on the base 220 of the exercise and therapy device 210. The handle 232 can increase the ease with which the exercise and therapy device 210 can be picked up and moved.

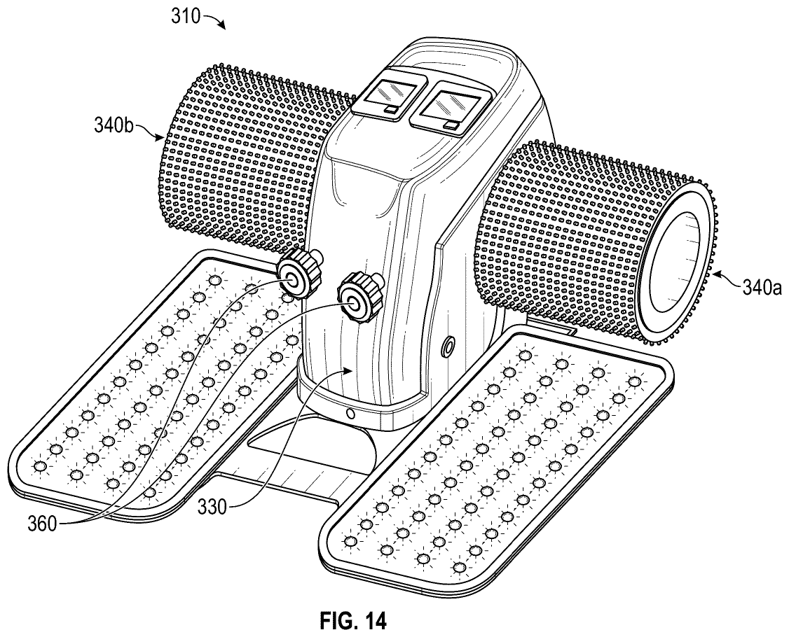

FIG. 14 illustrates a front, top perspective view of another embodiment of an exercise and therapy device 310 which may include similar structural and/or operational features to any of the other example exercise and therapy devices disclosed herein. The exercise and therapy device 310 can include rollers 340a, 340b, a housing 330 and/or controls 360. The controls 360 can be interacted with to adjust the resistance acting against rotation of the rollers 340a, 340b. The controls 360 can be knobs. The controls 360 can be positioned on a front surface of the housing 330.

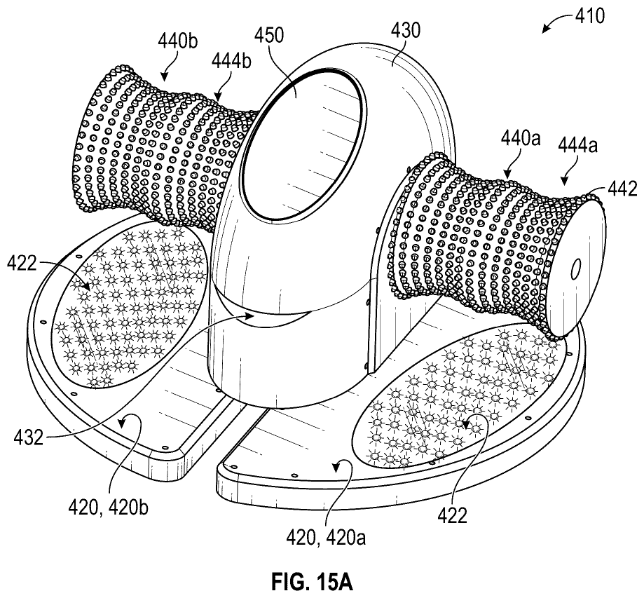

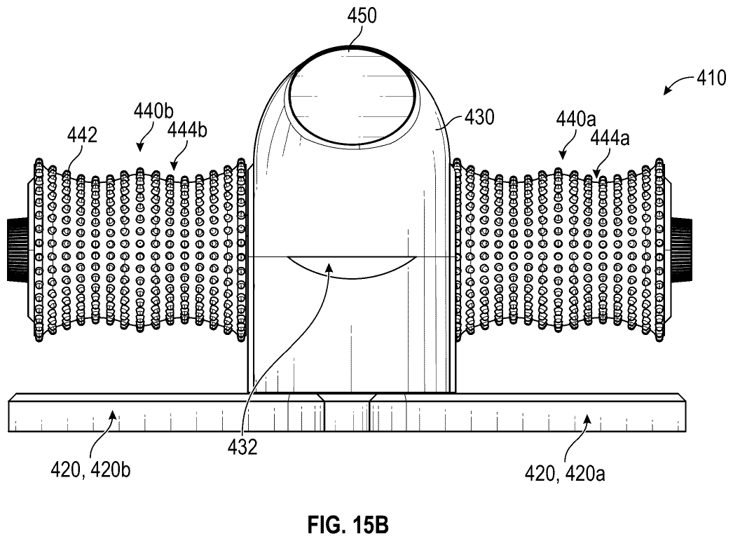

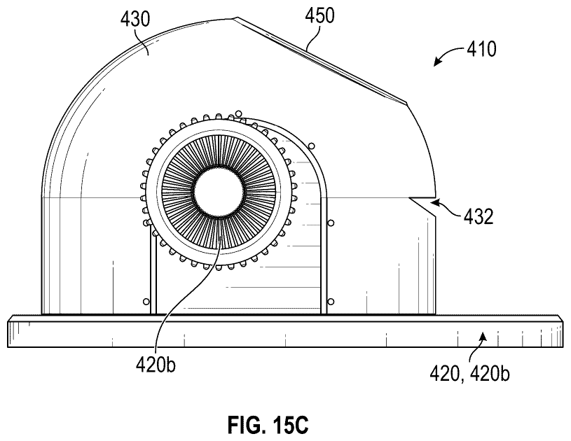

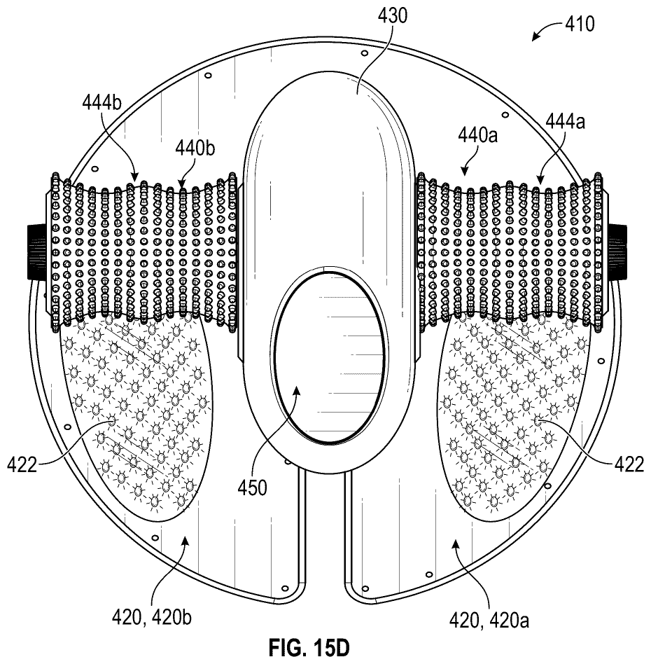

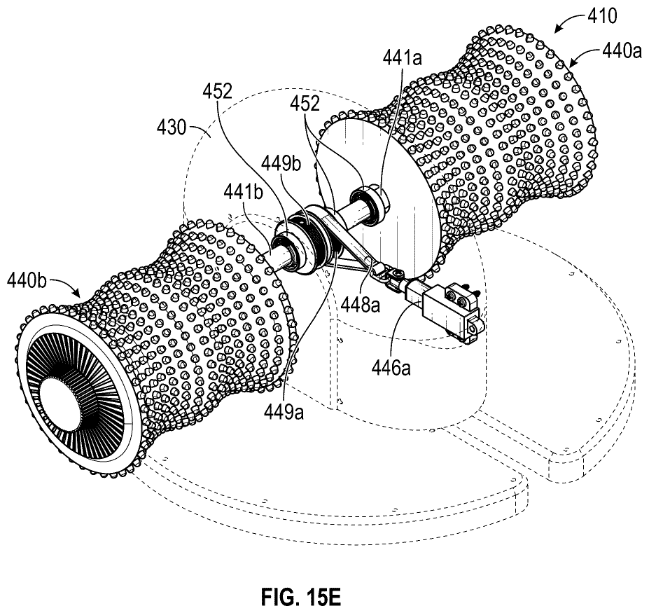

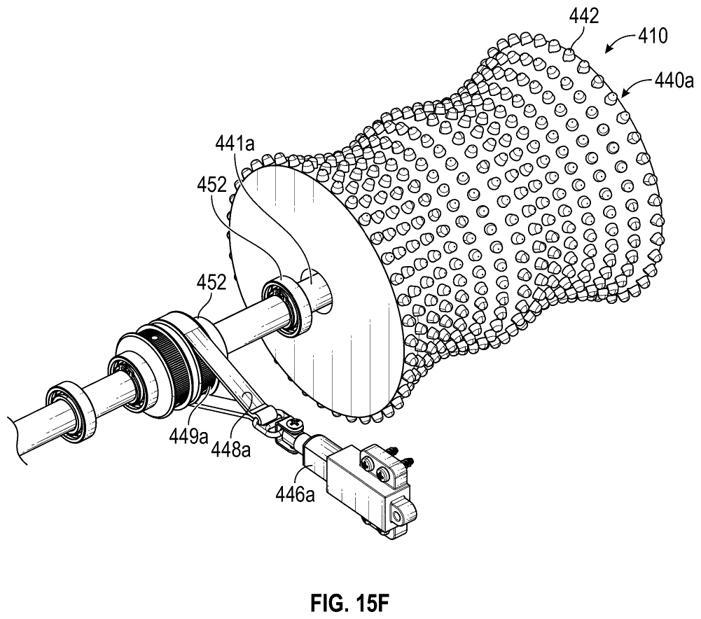

FIGS. 15A-15F illustrate various views of another embodiment of an exercise and therapy device 410. The exercise and therapy device 510 can include the same or similar structural and/or operational features of any of the other example exercise and therapy devices disclosed herein, for example, the exercise and therapy devices 10, 10′, 110, 210, 310, and/or 510. For example, the exercise and therapy device 410 can include a base 420, a housing 430 (e.g., without limitation, support), a first roller 440a, a second roller 440b, a first shaft (e.g., without limitation, axle, rod, bar) 441a, and/or a second shaft (e.g., without limitation, axle, rod, bar) 441b which can include any of the features described with respect to any of the other bases, housings, rollers, and/or axles described herein, respectively. FIG. 15A illustrates a front, top perspective view of the exercise and therapy device 410. FIG. 15B illustrates a front view of the exercise and therapy device 410. FIG. 15C illustrates a side view of the exercise and therapy device 410. FIG. 15D illustrates a top view of the exercise and therapy device 410.

As shown in at least FIGS. 15A-15D, the rollers 440a, 440b can be partially or substantially cylindrical in shape. In some embodiments, the rollers 440a, 440b can have a variable diameter. For example, the rollers 440a, 440b can have a similar or identical shape to the rollers 40a, 40b described with respect to FIGS. 1-8. The rollers 440a, 440b can be hollow. The rollers 440a, 440b (a rotational axis thereof) can be coaxial. In some embodiments, the rotational axis of the rollers 440a, 440b can be substantially horizontal. The rollers 440a, 440b can be independently rotatable (e.g., without limitation, free to rotate relative to each other). For example, the roller 440a can rotate without affecting (e.g., without limitation, causing a rotation in) the roller 440b and vice versa. The rollers 440a, 440b can rotate bidirectionally, for example, in a clockwise and counterclockwise direction.

The rollers 440a, 440b can include contact surfaces 444a, 444b which can include any of the features described with respect to any of the contact surfaces described herein. The contact surfaces 444a, 444b can extend along the outer, curved surface (e.g., without limitation, the outer circumference) of the rollers 440a, 440b. The contact surfaces 444a, 444b can include surface features 442 which can include any of the features described with respect to any of the surface features described herein. The surface features 442 can extend along at least a portion of (e.g., without limitation, all or substantially all of) the contact surfaces 444a, 444b. The surface features 442 can include a plurality of projections which may extend outward (e.g., without limitation, radially outward) from the corresponding contact surface 444a, 444b. The surface features 442 can have a cross-sectional shape that is hexagonal, rectangular, circular, or any other appropriate shape. For example, the surface features 442 can be hemispherical in shape. The surface features 442 can be arranged in rows across the corresponding contact surface 444a, 444b. In some embodiments, the surface features 442 can be arranged across the corresponding contact surface 444a, 444b in one or more geometric patterns (e.g., without limitations, a sinusoidal pattern, a zig-zag pattern, a helical pattern, a honeycomb pattern, a chevron pattern, or any other appropriate geometric pattern). In some embodiments, the surface features 442 can be arranged across the corresponding contact surface 444a, 444b in a random or pseudo-random pattern.

In some embodiments, the base 420 can include a first base portion 420a (e.g., without limitation, a right base portion) and a second base portion 420b (e.g., without limitation, a left base portion) which can include any of the features described with respect to other base portions described herein, for example, the base portions 20a, 20b. The base 420 (e.g., without limitation, the base portions 420a, 420b) can support the exercise and therapy device 410 and/or can provide a surface on which a user can rest their feet when not utilizing the rollers 440a, 440b. The base portions 420a, 420b (e.g., without limitation, a front of the base portions 420a, 420b) can be separated by a gap. In some embodiments, the base 420 can be circular in shape. For example, the base portions 420a, 420b can be semi-circular in shape. The base portions 420a, 420b, when viewed together, can form a partially or substantially circular shape.

The exercise and therapy device 410 can include a plurality of light emitters 422 which can include any of the features described with respect to any of the other light emitters described herein. For example, the light emitters 422 can be included in (e.g., without limitation, housed within) the base 420 (e.g., without limitation, one or both base portions 420a, 420b). The base 420 (e.g., without limitation, one or both base portions 420a, 420b) can include a transparent or semi-transparent top surface such that light can be emitted from the light emitters 422 through the base 420. A user can place his or her feet on the top surface of the base 420 (e.g., without limitation, one or both base portions 420a, 420b) such that at least some of the light emitted from the light emitters 422 is received by the user's foot or feet. In some embodiments, the light emitters 422 can emit light that is substantially red in color. The light emitters 422 can emit light with a wavelength of from 550 nm or approximately 550 nm to 800 nm, approximately 800 nm, or more than 800 nm, for example, from 600 nm or approximately 600 nm to 750 nm, approximately 750 nm, or more than 750 nm, from 625 nm or approximately 625 nm to 725 nm, approximately 725 nm, or more than 725 nm, or any value or ranges of values between or bounded by any of these values or ranges.

The housing 430 can be coupled to the base 420 (e.g., without limitation, the base portions 420a, 420b). The housing 430 can extend upward away from the base 420. The housing 430 can include a rounded profile. The housing 430 (e.g., without limitation, one or more outer surfaces thereof) can lack sharp edges and/or corners to decrease the risk of a user harming themselves while utilizing the exercise and therapy device 410. The first shaft 441a and the second shaft 441b can be at least partially disposed within the housing 430. A portion of the first shaft 441a and a portion of the second shaft 441b can extend from the housing 430. In some embodiments, portions of the shafts 441a, 441b can extend from opposite, lateral sides of the housing 430 such that a portion of the first shaft 441a and a portion of the second shaft 441b extend from the sides of the housing 30 in substantially opposite directions.

The shafts 441a, 441b can be rotated in a forward or rearward direction independently of each other. For example, the shafts 441a, 441b can be rotated in the same or different directions and/or at the same or different speeds. In some embodiments, the shafts 441a, 441b can be coaxial such that the first shaft 441a and second shaft 441b can rotate about the same axis of rotation. The first roller 440a can be coupled to the first shaft 441a such that the first roller 440a rotates with the first shaft 441a (e.g., without limitation, at the same rotational speed). The second roller 440b can be coupled to the second shaft 441b such that the second roller 440b rotates with the second shaft 441b (e.g., without limitation, at the same rotational speed). The shafts 441a, 441b can be disposed at least partially within the respective roller 440a, 440b. The shafts 441a, 441b can be coaxial with the respective roller 440a, 440b.

The exercise and therapy device 410 can include a display 450 which can include any of the features described with respect to any of the other displays described herein, for example, the display 50. The display 450 can display any information derived from one or more sensors (e.g., the one or more sensors 94a, 94b) measuring one or more parameters relating to the rollers 540a, 540b (e.g., without limitation, rotational speed, rotational direction, completion of a rotation, number of rotations, exerted pressure, time rotating, etc.). For example, the display 450 can show information relating to the rotation of the rollers 440a, 440b and/or the rotation of the shafts 441a, 441b such as the total number of rotations, the number of rotations per a time period, the speed of rotation, etc. The display 450 can additionally or alternatively display time remaining in a therapy session or stage, time remaining still the start of the next therapy session or stage, estimated calories burned, and/or one or more numerical values representing the resistance acting against the rotation of one or both rollers 440a, 440b. The display 450 can be positioned on a top surface of the housing 430. The display 450 can be angled forward (e.g., without limitation, toward the user) to allow a user to more easily view the information on the display 450. In some embodiments, the display 450 can be a touchscreen and a user can interact (e.g., without limitation, touch) the display 450 to modify the displayed information and/or modify operation of the exercise and therapy device 410 (e.g., without limitation, start, stop, or pause a therapy session, select a therapy session type, modify the resistance acting against rotation of one or both rollers 440a, 440b, etc.). A user can interact with the display 450 (for example, when the display 450 includes a touch screen) to affect operation of the exercise and therapy device 510. For example, a user can adjust the resistance of one or both rollers 540a, 540b via interaction with the display 450.

The exercise and therapy device 410 can include a handle 432 which can include any of the features described with respect to any of the other handles described herein. For example, the handle 432 can be gripped by a user to pick up and/or move the device 410. The handle 432 can be coupled to the housing 430. In some embodiments, the handle 432 can be integrally formed with the housing 430. The handle 432 can be positioned on a front of the housing 430. In some embodiments, the handle can include a recess that a user can insert their fingers into to grasp or lift the device 410.

FIG. 15E illustrates a front, top perspective view of the exercise and therapy device 410 with a housing 430 of the exercise and therapy device 410 shown as transparent and certain components of the exercise and therapy device 410 removed to better illustrate various internal components of the exercise and therapy device 410. FIG. 15F illustrates a front, top perspective view of the exercise and therapy device 410 with certain components of the exercise and therapy device 410 removed. In some embodiments, the exercise and therapy device 410 can include a first friction member 448a (also referred to herein as a first resistance member), a second friction member (also referred to herein as a second resistance member-not shown), a first collar 449a, a second collar 449b, a first actuator 446a, and/or a second actuator (not shown), which can include any of the features described with respect to any of the other friction members, collars, and/or actuators described herein, respectively. The first friction member 448a can apply a first adjustable frictional force (e.g., without limitation, directly or indirectly) to the first shaft 441a to resist rotation of the first roller 440a. The second friction member (not shown) can apply a second adjustable frictional force (e.g., without limitation, directly or indirectly) to the shaft 441b to resist rotation of the second roller 440b. In some embodiments, for example, as shown in FIG. 15E, the friction member 448a can be a belt that can be tensioned and dentensioned to adjust the level of resistance that is experienced by the respective roller. In some embodiments, the friction member 448a can apply a frictional force to the collar 449a. For example, the first friction member 448a can at least partially surround the collar 449a to generate a frictional force between the friction member and the collar 449a. The second friction member (not shown) can be similar or identical to the first friction member 448a. The second friction member (not shown) can be utilized in a similar or identical manner to the first friction member 448a to affect rotation of the second collar 449b, the second shaft 441b, and/or the second roller 440b.

The collars 449a, 449b can include any of the features described with respect to any of the other collars described herein, for example, the collars 49a, 49b. The collar 449a can be coupled to the shaft 441a such that the collar 449a rotates with the shaft 441a. In some embodiments, the collars 449a, 449b can be integrally formed with the shaft. The collar 449b can be coupled to the shaft 441b such that the collar 449b rotates with the shaft 441b. Thus, applying a frictional force (e.g., without limitation, via the friction member 448a) to the collar 449a to resist rotation of the collar 449a also resists rotation of the shaft 441a and the roller 440a. Similarly, applying a frictional force (e.g., without limitation, via the second friction member (not shown)) to the collar 449b to resist rotation of the collar 449b also resists rotation of the shaft 441b and the roller 440b. In some embodiments, the collars 449a, 449b can be ribbed (e.g., without limitation, ridged) to increase the frictional force generated between the collars 449a, 449b and the respective friction member 448a, (not shown) and/or decrease the risk of the respective friction member 448a, (not shown) slipping.

The frictional force resisting rotation of the shafts 441a, 441b (and thus the rollers 440a, 440b) can be adjusted via one or more actuators. For example, a first actuator 446a can be actuated to adjust the frictional force resisting rotation of the first shaft 441a. A second actuator (not shown) can be actuated to adjust the frictional force resisting rotation of the second shaft 441b. The second actuator (not shown) can be similar or identical to the first actuator 446a. The second actuator (not shown) can be operated in a similar or identical manner as the first actuator 446a to affect rotation of the second collar 449b, the second shaft 441b, and/or the second roller 440b. The first actuator 446a and the second actuator (not shown) can be operated (e.g., without limitation, adjusted) independently of each other. The first actuator 446a can tension and/or detension the first friction member 448a to adjust the frictional force created between the first friction member 448a and the collar 449a. In some embodiments, the first actuator 446a can be a linear actuator that can be extended and/or retracted. As shown in the embodiment of FIGS. 15E & 15F, the actuator 446a can be extended to detension the friction member 448a, thereby decreasing the frictional force between the friction member 448a and the collar 449a to decrease the force resisting rotation of the roller 440a. Conversely, the actuator can be retracted to tension the friction member 448a, thereby increasing the frictional force between the friction member 448a and the collar 449a to increase the force resisting rotation of the roller 440a. In some embodiments, the orientation of the actuator 446a can be reversed such that extending the actuator 446a tensions the friction member 448a and retracting the actuator 446a detensions the friction member 448a.

In some embodiments, the exercise and therapy device 410 can include a plurality of bearings 452. The bearings 452 can include roller bearings, ball bearings, needle bearings, bushings, plain bearings, and/or any combination thereof. The bearings 452 can be disposed around the shafts 441a, 441b. For example, the shaft 441a can include one or more (e.g., without limitation, two) bearings 452 and/or the shaft 441b can include one or more (e.g., without limitation, two) bearings 452. In some embodiments, a first bearing 452 can be disposed between the shafts 441a, 441b and the housing 430. In some embodiments, a second bearing 452 can be disposed between the shafts 441a, 441b and the corresponding roller 440a, 440b. The bearings 452 can enable or support rotational movement of the shafts 441a, 441b and thus the rollers 440a, 440b.

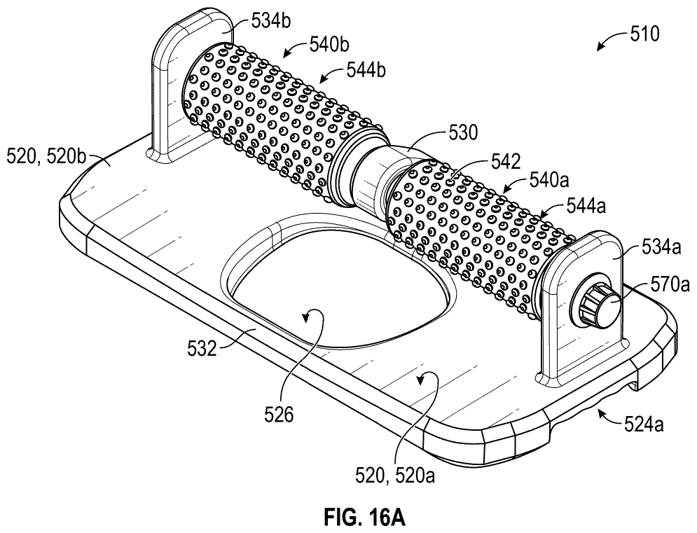

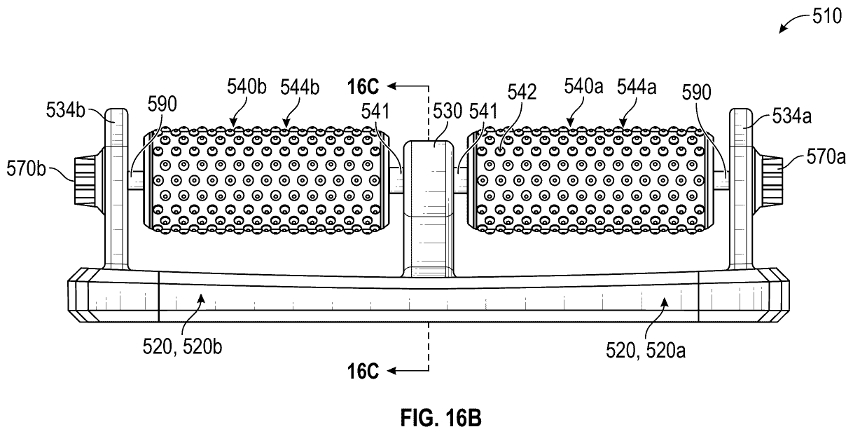

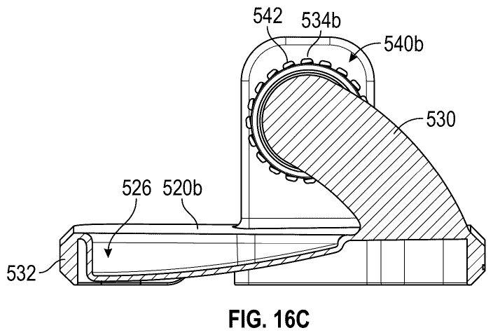

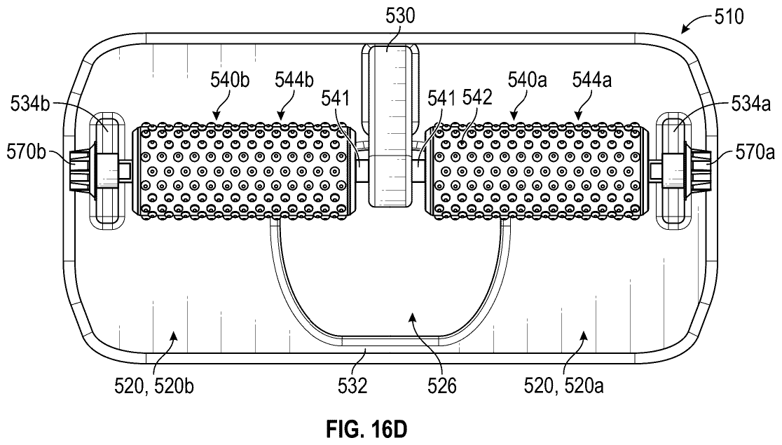

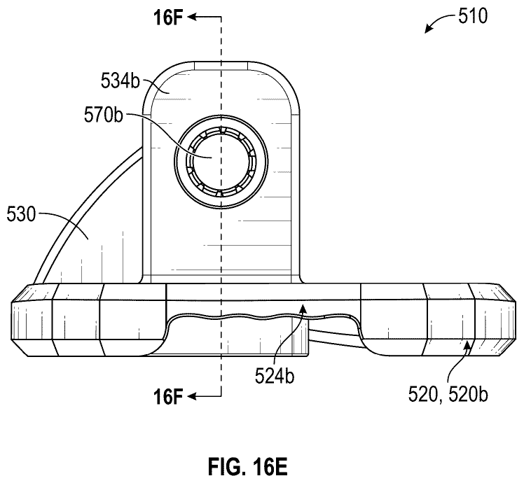

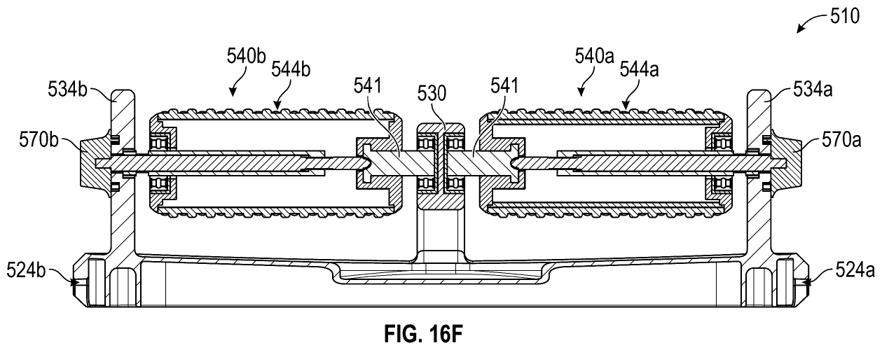

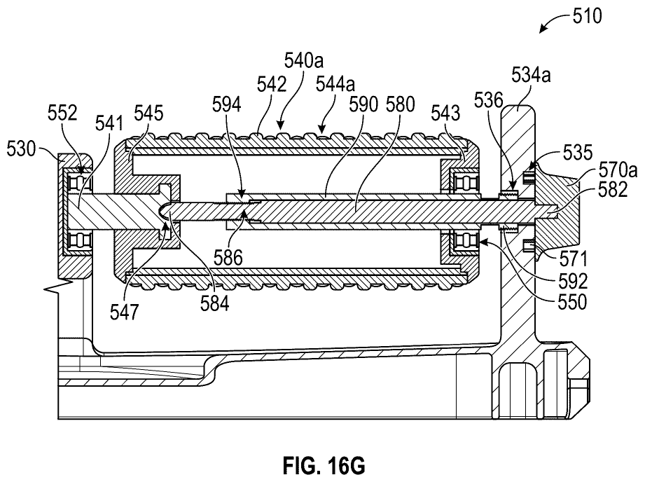

FIGS. 16A-16G illustrate various views of another embodiment of an exercise and therapy device 510. The exercise and therapy device 510 can include similar structural and/or operational features to any of the other example exercise and therapy devices disclosed herein, for example, the exercise and therapy devices 10, 10′, 110, 210, 310, and/or 310. For example, the exercise and therapy device 510 can include one or more rollers 540a, 540b which can include contact surfaces 544a, 544b which can include any of the features described with respect to any of the contact surfaces described herein. For example, the contact surfaces 544a, 544b can include surface features 542 which can include any of the features described with respect to any of the surface features described herein. FIG. 16A illustrates a front, top perspective view of the exercise and therapy device 510. FIG. 16B illustrates a front view of the exercise and therapy device 510. FIG. 16C illustrates a side (e.g., without limitation, right side), cross-sectional view of the exercise and therapy device 510 taken along line A-A of FIG. 16B. FIG. 16D illustrates a top view of the exercise and therapy device 510. FIG. 16E illustrates a side (e.g., without limitation, left side) view of the exercise and therapy device 510. FIG. 16F illustrates a front, cross-sectional view of the exercise and therapy device 510 taken along line B-B of FIG. 16E. FIG. 16G illustrates a front, cross-sectional view of a first portion (e.g., without limitation, right half) of the exercise and therapy device 510 taken along line B-B of FIG. 16E.

As shown in at least FIGS. 16A-16D, the rollers 540a, 540b can be partially or substantially cylindrical in shape. In some embodiments, the rollers 540a, 540b can have a variable diameter. For example, the rollers 540a, 540b can have a similar or identical shape to the rollers 40a, 40b described with respect to FIGS. 1-8. The rollers 540a, 540b can be hollow, for example, as shown in FIG. 16F. The rollers 540a, 540b (a rotational axis thereof) can be coaxial, for example, along a horizontal axis. The rollers 540a, 540b can be independently rotatable (e.g., without limitation, free to rotate relative to each other). For example, the roller 540a can rotate without affecting (e.g., without limitation, causing a rotation in) the roller 540b and vice versa. The rollers 540a, 540b can rotate bidirectionally, for example, in a clockwise and counterclockwise direction.

The contact surfaces 544a, 544b can extend along the outer, curved surface (e.g., without limitation, the outer circumference) of the cylindrical rollers 540a, 540b. The surface features 542 can extend along at least a portion of (e.g., without limitation, all or substantially all of) the corresponding contact surface 544a, 544b. The surface features 542 can include a plurality of projections which may extend outward (e.g., without limitation, radially outward) from the contact surfaces 544a, 544b. The surface features 542 can have a cross-sectional shape that is hexagonal, rectangular, circular, or any other appropriate shape. For example, the surface features 542 can be hemispherical in shape. The surface features 542 can be arranged in rows across the respective contact surface 544a, 544b. In some embodiments, the surface features 542 of a row can be offset from the surface features 542 of one or more adjacent rows (e.g., without limitation, both adjacent rows). For example, the surface features 542 of a first row can be unaligned with the surface features of a second and/or third adjacent row along the circumference of the respective roller 540a, 540b.

The exercise and therapy device 510 can include a base 520 which can include any of the features described with respect to any of the other bases described herein. For example, the base 520 can include a first base portion 520a (e.g., without limitation, a right base portion) and a second base portion 520b (e.g., without limitation, a left base portion). The base 520 (e.g., without limitation, the base portions 520a, 520b) can support the exercise and therapy device 510 and/or can provide a surface on which a user can rest their feet when not utilizing the rollers 540a, 540b. In some embodiments, the base 520 can include an opening 526 (e.g., without limitation, a recess) positioned between the base portions 520a, 520b. The opening 526 can extend into the base 520 from a top surface of the base 520. The opening 526 can form a recessed portion of the base 520. In some embodiments, the opening 526 can extend through the entirety of the base 520 (e.g., without limitation, can form a through hole).

The exercise and therapy device 510 can include a handle 532. The handle 532 can form a portion of the base 520. For example, the handle 532 can extend between and/or connect the first and second base portions 520a, 520b. The handle 532 can be positioned proximate a front of the base 520. The handle 532 can be positioned between the opening 526 and the front of the base 520. The opening 526 can define a wall (e.g., without limitation, an inward wall) of the handle 532. In some embodiments, the exercise and therapy device 510 can additionally or alternatively include one or more handles 524a, 524b (see at least FIGS. 16A, 16E, & 16F). The handles 524a, 524b can be disposed at the base 520, for example, the first base portion 520a and the second base portion 520b, respectively. The handles 524a, 524b can be positioned on opposite lateral sides of the base 520 such that a user can grip each handle 524a, 524b with a separate hand to maneuver (e.g., without limitation, lift, move) the base 520 and thus the exercise and therapy device 510. In some aspects, any or all of the handles 532, 524a, 524b can be integrally formed with the base 520.

The exercise and therapy device 510 can include one or more supports 530, 534a, 534b (which may also be referred to herein as arms, housings, and/or mounts). For example, the exercise and therapy device 510 can include a central support 530, a first lateral support 534a, and/or a second lateral support 534b. The supports 530, 534a, and/or 534b can be coupled to and/or extend from the base 520. In some embodiments, the supports 530, 534a, and/or 534b can be integrally formed with the base 520. The central support 530 (e.g., without limitation, a proximal end thereof) can be positioned at and/or extend from a central portion of the base 520. In some embodiments, the central support 530 can extend from a portion of the base adjacent (e.g., without limitation, behind) the opening 526. The central support 530 can angle and/or curve (e.g., without limitation, inward toward a center of the base 520) from the base 520 such that a free (e.g., without limitation, distal) end of the central support 530 is positioned proximate a longitudinal midpoint of the base 520 (e.g., without limitation, above the opening 526). The first lateral support 534a can be positioned proximate and/or extend from a first lateral side (e.g., without limitation, a right side) of the base 520 and the second lateral support 534b can be positioned proximate and/or extend from a second, opposite lateral side (e.g., without limitation, a left side) of the base 520. In some embodiments, the first and second lateral supports 534a, 534b can be substantially linear (e.g., without limitation, planar). The first and second lateral supports 534a, 534b can be positioned proximate and/or extend from a longitudinal midpoint of the base 520.

The supports 530, 534a, and/or 534b can support and/or couple (e.g., without limitation, rotationally) to one or more of the rollers 540a, 540b. For example, the roller 540a can extend between and/or rotationally couple to the central support 530 and the first lateral support 534a. The roller 540b can extend between and/or rotationally couple to the central support 530 and the second lateral support 534b. At least a portion of the supports 530, 534a, 534b (e.g., without limitation, distal portions thereof) can be aligned (e.g., without limitation, colinear) along a horizontal axis (e.g., without limitation, at or proximate a lateral axis of the base 520). For example, a portion of the supports 530, 534a, 534b that couple to the rollers 540a and/or 540b can be aligned (e.g., without limitation, colinear). The supports 530, 534a, 534b can position (e.g., without limitation, suspend) the rollers 540a, 540b above the base 520 such that the rollers 540a, 540b do not contact the base 520.

FIG. 16G illustrates a front, cross-sectional view of a first portion (e.g., without limitation, right half) of the exercise and therapy device 510 taken along line B-B of FIG. 16E. FIG. 16G illustrates the roller 540a and various components for adjusting (e.g., without limitation, mechanically) a resistance force acting against the rotation of the roller 540a. Similar or identical components to those shown in FIG. 16G can be included in the exercise and therapy device 510 to adjust the resistance force acting against the rotation of the roller 540b (for example, as shown in FIG. 16F). Thus, it will be appreciated that the following description relating to the roller 540a and the portion (e.g., without limitation, half) of the exercise and therapy device 510 shown in FIG. 16G is equally applicable to the roller 540b and the portion of the exercise and therapy device 510 not shown in FIG. 16G. As described elsewhere herein, the resistance force acting against the rollers 540a, 540b can be independently adjusted such that the force required to rotate each roller 540a, 540b can be independently adjusted.

The roller 540a can include a first end portion 543 (e.g., without limitation, outer end portion) and a second end portion 545 (e.g., without limitation, inner end portion). The first end portion 543 can be positioned proximate a first (e.g., without limitation, outer) end of the roller 540a and the second end portion 545 can be positioned proximate a second (e.g., without limitation, inner) end of the roller 540a. The end portions 543, 545 can form ends of the cylindrical roller 540a. In some embodiments, the end portions 543, 545 can include end caps which can be coupled to and/or decoupled from the roller 540a. In other embodiments, the end portions 543, 545 can be integrally formed with the roller 540a and/or the contact surface 544a. The end portions 543, 545 can be partially or substantially flush with the contact surface 544a to inhibit or prevent objects such as debris, clothes, and/or skin from catching on the roller 540a.

In some embodiments, a bearing 550 can be seated partially or substantially within the first end portion 543. The bearing 550 can include a roller bearing, ball bearing, needle bearing, bushing, plain bearing, and/or any combination thereof. The first end portion 543 can include a recess shaped and/or sized to receive the bearing 550. In some embodiments, the first end portion 543 can include a sleeve (e.g., without limitation, a stainless steel sleeve) seated partially or substantially within the first end portion 543 to receive the bearing 550. The sleeve can be molded integrally within the first end portion 543. The bearing 550 can enable or support rotational movement of the roller 540a.

In some embodiments, a bearing 552 can be seated partially or substantially within the central support 530. The bearing 552 can include a roller bearing, ball bearing, needle bearing, bushing, plain bearing, and/or any combination thereof. The central support 530 can include a recess shaped and/or sized to receive the bearing 552. In some embodiments, the central support 530 can include a sleeve (e.g., without limitation, a stainless steel sleeve) seated partially or substantially within the central support 530 to receive the bearing 552. The sleeve can be molded integrally within the support 530. The bearing 552 can enable or support rotational movement of the roller 540a.

The exercise and therapy device 510 can include a first shaft 541 (e.g., without limitation, axle, stepped shaft, rod, bar). The first shaft 541 can be coupled (e.g., without limitation, rotationally) to and/or extend from the central support 530. The first shaft 541 can rotationally couple to the central support 530 via the bearing 552 such that the first shaft 541 can rotate relative to the central support 530. The first shaft 541 can extend toward the roller 540a and/or the first lateral support 534a. The first shaft 541 can be axially aligned (e.g., without limitation, coaxial) with the roller 540a (e.g., without limitation, a rotational axis thereof). The first shaft 541 can couple to the roller 540a via the second end portion 545 such that the first shaft 541 and the roller 540a rotate together (e.g., without limitation, relative to the central support 530). For example, the first shaft 541 and the roller 540a can rotate simultaneously and/or at the same rotational speed. In some embodiments, the first shaft 541 can be integrally formed (e.g., without limitation, molded) with the second end portion 545. In some embodiments, the shaft 541 and the second end portion 545 can be stepped to facilitate coupling. For example, the shaft 541 can include a protruding portion (e.g., without limitation, a flange) shaped to be received in a recessed portion (e.g., without limitation, a seat) of the second end portion 545.

The exercise and therapy device 510 can include a second shaft 590 (e.g., without limitation, hollow shaft, exterior shaft, rod). The second shaft 590 can be hollow. The second shaft 590 can include one or more open ends. The second shaft 590 can extend through the bearing 550 and/or the first end portion 543. In some embodiments, the second shaft 590 does not rotate with the roller 540a. The second shaft 590 can include a first end 592 (e.g., without limitation, an outer end) and a second end 594 (e.g., without limitation, an inner end, inner tip) disposed at opposite ends of the second shaft 590. The first end 592 can engage with (e.g., without limitation, couple to) the first lateral support 534a. For example, the first lateral support 534a can include a recess 536 to receive the first end 592. In some embodiments, the first end 592 can be threaded and the recess 536 can be correspondingly threaded to couple the second shaft 590 to the first lateral support 534a. The second end 594 can be disposed within an interior of the roller 540a. In some aspects, the second end 594 can include interior threads (e.g., without limitation, threads disposed on in interior surface or circumference of the second end 594). The second shaft 590 can be axially aligned (e.g., without limitation, coaxial) with the first shaft 541, the bearings 550, 552, and/or the roller 540a (e.g., without limitation, the rotational axis thereof).

The exercise and therapy device 510 can include a third shaft 580 (e.g., without limitation, interior shaft, friction member, resistance member, actuator, rod). The third shaft 580 can be axially aligned (e.g., without limitation, coaxial) with the first shaft 541, the second shaft 590, the bearings 550, 552, and/or the roller 540a (e.g., without limitation, the rotational axis thereof). In some embodiments, the third shaft 580 does not rotate with the roller 540a. The third shaft 580 can extend through the first lateral support 534a, the bearing 550, the first end portion 543, the second shaft 590, and/or at least a portion of the second end portion 545. The third shaft 580 can be shaped and/or sized to fit within (e.g., without limitation, extend through) the hollow interior of the second shaft 590. The third shaft 580 can include a first end 582 (e.g., without limitation, an outer end) and a second end 584 (e.g., without limitation, an inner end) disposed at opposite ends of the third shaft 580. The first end 582 can engage with (e.g., without limitation, couple to) a control 570a (e.g., without limitation, which may also be referred to herein as an actuator) such that the third shaft 580 and the control 570a rotate together. For example, a user can rotate the control 570a (e.g., without limitation, clockwise or counterclockwise) to correspondingly rotate the third shaft 580. The control 570a can include a recess to receive the first end 582. In some embodiments, the first end 582 can be threaded and the recess of the control 570a can be correspondingly threaded to couple the third shaft 580 to the control 570a. In other embodiments, the first end 582 can be integrally formed with the control 570a.

The third shaft 580 can include a threaded portion 586 (e.g., without limitation, external threads) to engage with the interior threads of the second end 594 of the second shaft 590. The third shaft 580 can be rotated to axially move the third shaft 590 relative to the second shaft 590 (for example, due to the interaction between the threaded portion 586 of the third shaft 580 and the threaded second end 594 of the second shaft 590). For example, the third shaft 580 can be rotated in a first direction (e.g., without limitation, clockwise or counterclockwise) to advance the third shaft 580 inward toward the central support 530 and/or the first shaft 541. The third shaft 580 can be rotated in a second, opposite direction (e.g., without limitation, clockwise or counterclockwise) to retreat (e.g., without limitation, retract) the third shaft outward away from the central support 530 and/or the first shaft 541. The first rotational direction may be referred to herein as a tightening direction while the second rotational direction may be referred to herein as a loosening direction. In some embodiments, the third shaft 580 can be advanced and retreated without rotation. For example, the third shaft 580 can be pushed and/or pulled (e.g., without limitation, in an axial direction) to advance and/or retract the third shaft 580.

The second end 584 can be shaped and/or sized to be received at least partially within a recess 547 of the first shaft 541. For example, the second end 584 of the third shaft 580 and the recess 547 can be tapered and/or conical in shape. The recess 547 of the first shaft 541 can be positioned at an inner end of the first shaft 541 (e.g., without limitation, an end of the first shaft 541 disposed within the roller 540a). In some embodiments, the second end 584 of the third shaft 580 includes external threads that engage with internal threads of the recess 547 of the first shaft 541. When the third shaft 580 is advanced (e.g., without limitation, inward toward the first shaft 541), the second end 584 can advance toward and/or against the recess 547 to increase axial compression and/or a frictional force between the third shaft 580 (e.g., without limitation, the second end 584 thereof) and the first shaft 541 (e.g., without limitation, the recess 547 thereof). Conversely, when the third shaft 580 is retreated, the second end 584 can move away from the recess 547 to decrease axial compression and/or a frictional force between second end 584 and the recess 547. The axial compression and/or frictional force between the third shaft 580 and the first shaft 541 (e.g., without limitation, the second end 584 and the recess 547) can resist rotational movement of the roller 540a. Thus, the axial compression and/or frictional force between the third shaft 580 and the first shaft 541 (which may be referred to herein as a resistance force) can be adjusted to adjust the resistance acting against rotation of the roller 540a. In some embodiments, a user can adjust (e.g., without limitation, control) the position (e.g., without limitation, axial position) of the third shaft 580 to adjust the resistance force in order to adjust the force required by a user to rotate the roller 540a. For example, a user can rotate the third shaft 580 in the tightening direction (e.g., without limitation, via rotation of the control 570a) to axially advance the third shaft 580, thereby increasing the resistance force acting against rotation of the first roller 540a. Conversely, a user can rotate the third shaft 580 in the loosening direction (e.g., without limitation, via rotation of the control 570a) to axially retract the third shaft 580, thereby decreasing the resistance force acting against rotation of the first roller 540a. In this manner, a user can adjust the resistance force to suit their individual needs. As described elsewhere herein, a user can independently adjust the resistance force acting against the rotation of each roller 540a, 540b independently (for example, by rotating the controls 570a, 570b independently) to independently adjust the force required to rotate each roller 540a, 540b.

In some embodiments, the controls 570a, 570b can be a knob. In other embodiments, the controls 570a, 570b can be one or more buttons, sliders, switches, touchscreens, or any other appropriate form of a user control that can be manipulated by a user. In some embodiments, the controls 570a, 570b can be lockable at one or more (e.g., without limitation, a continuum of) rotational positions. For example, the controls 570a, 570b can be a locking knob. After a user rotates the control 570a, 570b to the desired position (e.g., without limitation, corresponding to the desired resistance force), the user can lock the control 570a, 570b in its current rotational position to set (e.g., without limitation, lock) the roller 540a, 540b at the desired resistance force. Providing a lockable control 570a, 570b may prevent or inhibit unintentional movement of the third shaft 580, for example, due to vibration and/or repeated rotation of the rollers 540a, 540b, which may provide a more consistent resistance force during use. In some aspects, the controls 570a, 570b can include one or more locking protrusions 571. The locking protrusions 571 can be received at least partially within one or more recesses 535 in the respective lateral support 534a, 534b to lock (e.g., without limitation, rotationally lock) the controls 570a, 570b (and thus the corresponding third shaft 580) in position. In some aspects, the locking protrusions 571 can be removed from the recesses 535 (for example, but moving the control 570a, 570b outward) when a user wishes to rotate the control 570a, 570b to adjust the resistance force.

In some embodiments, the rollers 540a, 540b can include one or more distinct visual identifiers (e.g., without limitation, differentiators) which may allow a user to quickly and/or easily identify each roller 540a, 540b. For example, the roller 540a can include a distinct visual identifier from the roller 540b to a user to more easily identify which roller 540a, 540b is intended for use with which foot (e.g., without limitation, the left foot or right foot). In some embodiments, the visual identifier can include one or more colors. For example, one roller 540a, 540b (e.g., without limitation, the contact surfaces 544a, 544b thereof) can be a first color (e.g., without limitation, grey, light grey) while the other roller 540a, 540b can be a different, visually distinguishable color (e.g., without limitation, blue, dark grey). In some embodiments, the visual identifiers can include one or more colors, patterns (e.g., without limitation, stripes, dots, dashes, etc.), surface textures (e.g., without limitation, matte, glossy), directional arrows (e.g., without limitation, arrows pointing left and/or right), letters (e.g., without limitation, “L” to indicate left and/or “R” to indicate right), icons, or any combination thereof to allow a user to distinguish the rollers 540a, 540b. In some embodiments, the visual identifiers can include the arrangement of surface features 544 on the respective rollers 540a, 540b. For example, the first roller 540a can include a first geometric arrangement of surface features 544 while the second roller 540b can include a second, visually distinct geometric arrangement of surface features 544. In some embodiments, the texture of the surface features 544 of the rollers 540a, 540b can be distinct (e.g., without limitations, different firmness, elasticity, material, etc.).

The described visual identifiers may more effectively and/or reliably allow certain users (e.g., without limitation, neurodivergent users such as users with autism, ADHD, Dyspraxia, and/or sensory processing disorders) to distinguish between the rollers 540a, 540b. For example, the visual identifiers may be more effective when compared to verbal commands instructing a user which roller 540a, 540b should be used with each foot. Certain individuals, such as individuals with receptive language delays and/or auditory overload, may be able to more easily and/or quickly process visual information compared to auditory information. Furthermore, visual identifiers can provide constant and non-transient prompts for a user, compared to verbal instructions which are transient and can be presented inconsistently. Providing constant and non-transient prompts may allow certain individuals to repeatedly reference the same prompt each time they utilize the exercise and therapy device 510 which may allow certain users to use the exercise and therapy device 510 more consistently and/or confidently. The visual identifiers may reduce or eliminate the need for verbal instructions for a user to correctly utilize the exercise and therapy device 510. This may allow the device 510 to be used in shared environments such as classrooms, workplaces, and/or clinical settings without requiring contemporaneous instruction or signaling, thereby allowing the device 510 to be used without creating auditory distractions for bystanders.

In some embodiments, one roller 540a, 540b can be blue and/or the other roller 540a, 540b can be gray to visually distinguish the rollers 540a, 540b. The color blue may provide an active cue for the user (e.g., without limitation, indicating that the blue roller 540a, 540b is either the “right” or “left” roller 540a, 540b) while the color grey may provide a baseline reference (e.g., without limitation, indicating that the grey roller 540a, 540b is the other of the “right” and “left” rollers 540a, 540b). The color blue may lower physiological arousal, improve sustained attention, and/or reduce anxiety and/or sympathetic activation in certain individuals. The color grey may provide minimal sensory activation, minimize emotional and/or semantic bias, reduce novelty response, and/or provide visual rest for the user. It will be appreciated that while the rollers 540a, 540b are described as blue and/or grey herein, the rollers 540a, 540b can include any other color as appropriate. While the visual identifiers have been described with respect to the exercise and therapy device 510 (e.g., without limitation, the rollers 540a, 540b thereof), it will be appreciated that the visual identifiers can be equally applicable to any of the therapy devices (e.g., without limitation, the rollers thereof) described herein.

In some embodiments, rotating the rollers of any of the exercise and therapy devices disclosed herein can be relatively quiet. This may increase user productivity while using the exercise and therapy device and/or decrease unwanted attention from using the exercise and therapy device. For example, rotating the rollers can produce noise less than 100 dB or approximately 100 dB, less than 90 dB or approximately 90 dB, less than 80 dB or approximately 80 dB, less than 70 dB or approximately 70 dB, less than 60 dB or approximately 60 dB, less than 50 dB or approximately 50 dB, less than 40 dB or approximately 40 dB, less than 30 dB or approximately 30 dB, less than 20 dB or approximately 20 dB, less than 10 dB or approximately 10 dB, or any value or range of values between or bounded by any of these values or ranges.

In some embodiments of any of the exercise and therapy devices disclosed herein, a user can be provided with auditory prompting instructing the user on how and/or when to utilize the exercise and therapy device (e.g., without limitation, rotate one or more rollers thereof). For example, in some embodiments, an exercise and therapy device can include one or more audio output devices (e.g., without limitation, loudspeakers, headphones, headset, earbuds, etc.) that provide (e.g., without limitation, emit) sound. The one or more audio output devices can emit sound such as audible instructions (e.g., without limitation, words), tones, music, and/or sound effects to indicate when and/or how a user should rotate the rollers of the exercise and therapy device. In some embodiments, the audio output device (e.g., without limitation, loudspeaker, headphones, earbuds, etc.) can be separate from the exercise and therapy device. For example, the audio output device can be included in a remote device such as a smartphone, computer, laptop, etc. The audio output device can emit auditory prompts indicating which roller(s) (e.g., without limitation, left vs right) the user should rotate, when and/or for how long the user should rotate the roller(s), how quickly the user should rotate the roller(s), how much force a user should exert on the roller(s), when and/or for how long the user should stop rotating the roller(s), an estimate of how many calories the user has burned, etc. The audio output device can emit auditory prompts containing separate instructions for each roller (e.g., without limitation, the left and right roller). In some embodiments, the auditory prompts can reference the visual identifiers to distinguish (e.g., without limitation, identify) the separate rollers.

In some embodiments, the auditory prompts can be provided without feedback from (e.g., without limitation, one or more signals received from) an exercise and therapy device. For example, the auditory prompts can be provided according to a predetermined prompt sequence independent of user interaction with the exercise and therapy device (e.g., without limitation, rotation of one or more rollers). In some embodiments, the auditory prompts can additionally or alternatively be provided in response to one or more signals received from the exercise and therapy device. For example, the auditory prompts can be provided in response to user interaction with the exercise and therapy device such as movement (e.g., without limitation, rotation) of one or more rollers. The auditory prompts can be provided in response to the number of rotations of the roller(s), rotational speed of the roller(s), asymmetry in rotational speed of the roller(s), time spent rotating the roller(s), etc. In some embodiments, the exercise and therapy device can include one or more sensors (such as the sensors 94a, 94b) to detect one or more parameters relating to one or both rollers such as rotational speed, time spent rotating, rotational asymmetry between the rollers, force exerted on the roller(s), force required to rotate the roller(s), etc. A processor (e.g., without limitation, controller) can receive one or more sensor signals from the sensor(s) containing the one or more parameters (e.g., without limitation, sensor data). The processor can determine (e.g., without limitation, according to instructions) whether the audio output device should produce one or more auditory prompts in response to receiving the one or more sensor signals. The processor can instruct the audio output device to produce one or more auditory prompts in response receiving the one or more sensor signals. In some embodiments, the processor can be included in the exercise and therapy device. In other embodiments, the processor be separate from the exercise and therapy device. For example, the processor can be included in a remote device such as a smartphone, computer, laptop, etc. which may or may not be the same remote device including the speaker. In some embodiments, a user can select between a plurality of audio prompts prior to and/or during use of the exercise and therapy device.

In some embodiments, the exercise and therapy device and/or a remote device can include one or more haptic output devices. The haptic output devices can produce vibrations to indicate how and/or when to utilize the exercise and therapy device (e.g., without limitation, rotate one or more rollers thereof) in a similar or identical manner to the one or more audio output devices described herein. The haptic output device(s) can be included in one or both rollers, for example, to vibrate one or both rollers.

### Additional Considerations and Terminology

Although this disclosure has been described in the context of certain examples, it will be understood by those skilled in the art that the present disclosure extends beyond the specifically disclosed examples to other alternative examples and/or uses of the disclosure and obvious modifications and equivalents thereof. In addition, while a number of variations of the disclosure have been shown and described in detail, other modifications, which are within the scope of this disclosure, will be readily apparent to those of skill in the art based upon this disclosure. It is also contemplated that various combinations or subcombinations of the specific features and aspects of the examples may be made and still fall within the scope of the disclosure. Accordingly, it should be understood that various features and aspects of the disclosure can be combined with or substituted for one another in order to form varying modes of the disclosed.

Features, materials, characteristics, or groups described in conjunction with a particular aspect, or example are to be understood to be applicable to any other aspect, or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing examples of devices or systems. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate embodiments can also be implemented in combination in a single embodiments. Conversely, various features that are described in the context of a single embodiments can also be implemented in multiple embodiments separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other embodiments. Those skilled in the art will appreciate that the actual steps taken in the processes illustrated and/or disclosed may differ from those shown in the figures. Depending on the system, certain of the steps described above may be removed, others may be added. Furthermore, the features and attributes of the specific examples disclosed above may be combined in different ways to form additional examples of systems, all of which fall within the scope of the present disclosure. Also, the separation of various system components in the embodiments described above should not be understood as requiring such separation in all embodiments, and it should be understood that the described components and systems can generally be integrated together in a single product or packaged into multiple products.

Conditional language used herein, such as, among others, “can,” “could,” “might,” “may,” “e.g.,” and the like, unless specifically stated otherwise, or otherwise understood within the context as used, is generally intended to convey that certain features, elements, and/or steps are optional. Thus, such conditional language is not generally intended to imply that features, elements, and/or steps are in any way required. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” refers to an amount that is within less than 10% of the stated amount. As another example, in certain embodiments, the terms “generally parallel” and “substantially parallel” refer to a value, amount, or characteristic that departs from exactly parallel by less than or equal to 10 degrees, 5 degrees, 3 degrees, or 1 degree. As another example, in certain embodiments, the terms “generally perpendicular” and “substantially perpendicular” refer to a value, amount, or characteristic that departs from exactly perpendicular by less than or equal to 10 degrees, 5 degrees, 3 degrees, or 1 degree.

While the above detailed description has shown, described, and pointed out novel features, it can be understood that various omissions, substitutions, and changes in the form and details of the devices or systems illustrated can be made without departing from the spirit of the disclosure. As can be recognized, certain portions of the description herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

The methods and tasks described herein can be performed and fully automated by a computer system. The computer system can, in some cases, include multiple distinct computers or computing devices (e.g., without limitation, physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., without limitation, solid state storage devices, disk drives, etc.). The various functions disclosed herein can be embodied in such program instructions, and/or can be implemented in application-specific circuitry (e.g., without limitation, ASICs or FPGAs) of the computer system. Where the computer system includes multiple computing devices, these devices can, but need not, be co-located. The results of the disclosed methods and tasks can be persistently stored by transforming physical storage devices, such as solid state memory chips and/or magnetic disks, into a different state. The computer system can be a cloud-based computing system whose processing resources are shared by multiple distinct entities or other users. The systems and modules can also be transmitted as generated data signals (for example, as part of a carrier wave or other analog or digital propagated signal) on a variety of computer-readable transmission mediums, including wireless-based and wired/cable-based mediums, and can take a variety of forms (for example, as part of a single or multiplexed analog signal, or as multiple discrete digital packets or frames).

Many other variations than those described herein will be apparent from this disclosure. For example, depending on the implementation, certain acts, events, or functions of any of the algorithms described herein can be performed in a different sequence, can be added, merged, or left out altogether (for example, not all described acts or events are necessary for the practice of the algorithms). Moreover, in certain implementations, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

Various illustrative logical blocks, modules, routines, and algorithm steps that can be described in connection with the disclosure herein can be implemented as electronic hardware (e.g., without limitation, ASICs or FPGA devices), computer software that runs on computer hardware, or combinations of both. Various illustrative components, blocks, and steps can be described herein generally in terms of their functionality. Whether such functionality is implemented as specialized hardware versus software running on general-purpose hardware depends upon the particular application and design constraints imposed on the overall system. The described functionality can be implemented in varying ways for each particular application, but such implementation decisions should not be interpreted as causing a departure from the scope of the disclosure.

Moreover, various illustrative logical blocks and modules that can be described in connection with the implementations disclosed herein can be implemented or performed by a machine, such as a general purpose processor, a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. A general purpose processor can be a microprocessor, controller, microcontroller, or state machine, combinations of the same, or the like. A processor can include electrical circuitry configured to process computer-executable instructions. A processor can include an FPGA or other programmable devices that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor can also include primarily analog components. For example, some, or all, of the signal processing algorithms described herein can be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of any method, process, routine, or algorithm described in connection with the disclosure herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC. The ASIC can reside in a user terminal. In the alternative, the processor and the storage medium can reside as discrete components in a user terminal.

What is claimed is:

1. An exercise and therapy device comprising:
a base;
a support coupled to the base;
a first roller extending away from the support;
a second roller extending away from the support;
a first resistance configured to selectively inhibit rotation of the first roller; and
a second resistance configured to selectively inhibit rotation of the second roller;
wherein the first roller and the second roller are rotatable independently of each other; and the first resistance and the second resistance are independently adjustable to separately modify a first force required to rotate the first roller and a second force required to rotate the second roller.

2. The exercise and therapy device of claim 1, further comprising:
a first shaft coupled to the support and the first roller, the first shaft configured to rotate with the first roller; and
a second shaft coupled to the support and the second roller, the second shaft configured to rotate with the second roller;
wherein the first resistance selectively inhibits rotation of the first shaft to selectively resist rotation of the first roller, and the second resistance selectively inhibits rotation of the second shaft to selectively resist rotation of the second roller.

3. The exercise and therapy device of claim 1, further comprising:
a first friction member configured to create a first frictional force resisting rotation of the first roller; and
a second friction member configured to create a second frictional force resisting rotation of the second roller;
wherein the first resistance comprises the first frictional force, and the second resistance comprises the second frictional force.

4. The exercise and therapy device of claim 3, wherein the first frictional force is adjustable such that increasing the first frictional force increases the first resistance and decreasing the first frictional force decreases the first resistance, the second frictional force is adjustable such that increasing the second frictional force increases the second resistance and decreasing the second frictional force decreases the second resistance, and the first frictional force and the second frictional force are independently adjustable.

5. The exercise and therapy device of claim 4, wherein the first friction member comprises a first belt and the second friction member comprises a second belt.

6. The exercise and therapy device of claim 5, further comprising:
a first actuator configured to adjust a tension of the first belt; and
a second actuator configured to adjust a tension of the second belt;
wherein:
increasing the tension of the first belt increases the first frictional force and decreasing the tension of the first belt decreases the first frictional force; and
increasing the tension in the second belt increases the second frictional force and decreasing the tension in the second belt decreases the second frictional force.

7. The exercise and therapy device of claim 4, wherein the first friction member comprises a first shaft and the second friction member comprises a second shaft.

8. The exercise and therapy device of claim 7, wherein:
the first shaft is configured to selectively advance into a third shaft and retreat away from the third shaft, the third shaft coupled to and configured to rotate with the first roller; and
the second shaft is configured to selectively advance into a fourth shaft and retreat away from the fourth shaft, the fourth shaft coupled to and configured to rotate with the second roller;
wherein:
extending the first shaft into the third shaft increases the first frictional force and retreating the first shaft away from the third shaft decreases the first frictional force; and
extending the second shaft into the fourth shaft increases the second frictional force and retreating the second shaft away from the fourth shaft decreases the second frictional force.

9. The exercise and therapy device of claim 8, further comprising:
a first rotatable actuator coupled to the first shaft; and
a second rotatable actuator coupled to the second shaft;
wherein:
rotating the first rotatable actuator in a first direction advances the first shaft into the third shaft, and rotating the first rotatable actuator in a second, opposite direction retreats the first shaft away from the third shaft; and
rotating the second rotatable actuator in the first direction advances the second shaft into the fourth shaft, and rotating the second rotatable actuator in the second, opposite direction retreats the second shaft away from the fourth shaft.

10. The exercise and therapy device of claim 1, further comprising:
a base;
a first arm coupled to the base; and
a second arm coupled to the base;
wherein:
the first roller is positioned between and supported by the support and the first arm, the support and the first arm positioning the first roller above the base; and
the second roller is positioned between and supported by the support and the second arm, the support and the first arm positioning the second roller above the base.

11. The exercise and therapy device of claim 1, wherein:
an outer surface of the first roller comprises a first visual identifier;
an outer surface of the second roller comprises a second visual identifier, the second visual identifier being visually distinct from the first visual identifier;
the first visual identifier comprises at least one of: a first color, a first pattern, a first icon, a first surface texture, a first icon, or any combination thereof; and
the second visual identifier comprises at least one of: a second color, a second pattern, a second icon, a second surface texture, a second icon, or any combination thereof.

12. The exercise and therapy device of claim 1, further comprising:
a first sensor configured to emit one or more first sensor signals in response to rotation of the first roller; and
a second sensor configured to emit one or more second sensor signals in response to rotation of the second roller.

13. The exercise and therapy device of claim 12, further comprising an audio output device configured to emit one or more first audio prompts comprising audible instructions for rotating the first roller in response to receiving the one or more first sensor signals and configured to emit one or more second audio prompts comprising audible instructions for rotating the second roller in response to receiving the one or more second sensor signals.

14. A system for exercise and therapy comprising:
the exercise and therapy device of claim 1; and
an audio output device configured to emit one or more audio prompts comprising audible instructions for using the exercise and therapy device.

15. The system of claim 14, wherein the audio output device is configured to emit one or more audio prompts according to a predetermined prompt sequence independently of any rotation of the first roller or the second roller.

16. The system of claim 14, wherein the audio output device is configured to emit one or more audio prompts in response to detected rotation of the first roller or the second roller.

17. The system of claim 16, wherein:
the exercise and therapy device further comprises:
a first sensor configured to emit a one or more first sensor signals in response to rotation of the first roller; and
a second sensor configured to emit one or more second sensor signals in response to rotation of the second roller; and
the audio output device is configured to emit one or more first audio prompts comprising audible instructions for rotating the first roller in response to receiving the one or more first sensor signals and configured to emit one or more second audio prompts comprising audible instructions for rotating the second roller in response to receiving the one or more second sensor signals.

18. A method for exercising at least a user's lower legs comprising:
rotating a first roller about a first axis extending through an axial centerline of the first roller, wherein a rotation of the first roller about the first axis is resisted by a first adjustable frictional force; and
rotating a second roller about a second axis extending through an axial centerline of the second roller, wherein a rotation of the second roller about the second axis is resisted by a second adjustable frictional force, wherein the first axis and the second axis are coaxial, and the second adjustable frictional force is not equal to the first adjustable frictional force.

19. The method of claim 18, further comprising varying the first adjustable frictional force independently of the second adjustable frictional force to vary a force required to rotate the first roller without varying the second adjustable frictional force.

20. The method of claim 18, wherein the first roller is rotated in response to a first audio prompt emitted by an audio output device, and the second roller is rotated in response to a second audio prompt emitted by the audio output device.
